(19) United States
(12) Patent Application Publication
(10) Pub. No.: US 2025/0048426 A1
(43) Pub. Date: Feb. 6, 2025

(54) Sidelink Unlicensed (SL-U) Channel Access

(71) Applicant: Fraunhofer-Gesellschaft zur Förderung der angewandten Forschung e.V., München (DE)

(72) Inventors: Gustavo Wagner OLIVEIRA DA COSTA, Erlangen (DE); Martin LEYH, Erlangen (DE); Dietmar LIPKA, Erlangen (DE); Elke ROTH-MANDUTZ, Erlangen (DE); Mehdi HAROUNABADI, Erlangen (DE); Dariush MOHAMMAD SOLEYMANI, Erlangen (DE)

(21) Appl. No.: 18/918,450

(22) Filed: Oct. 17, 2024

Related U.S. Application Data
(63) Continuation of application No. PCT/EP2023/060361, filed on Apr. 20, 2023.

(30) Foreign Application Priority Data
Apr. 22, 2022 (EP) 22169540.6

(51) Int. Cl. H04W 74/0808; H04W 16/14; H04W 92/18

(52) U.S. Cl. CPC H04W 74/0808; H04W 16/14; H04W 92/18

(57) ABSTRACT

Embodiments provide a transceiver of a 4th or 5th generation mobile communication system, wherein the transceiver is configured to operate in a sidelink mode, wherein the transceiver is configured, in the sidelink mode, to transmit or receive signals using radio resources in an unlicensed band, wherein the unlicensed band is one out of the following unlicensed bands:
the 2.4 GHz band,
the 5 GHz band with the exception of the intelligent transport system, ITS, band,
the 6 GHz band,
the 60 GHz band,
the 57 GHz to 71 GHz band,
unlicensed bands in FR2 range.

### CROSS-REFERENCE TO RELATED APPLICATIONS

This application is a continuation of copending International Application No. PCT/EP2023/060361, filed Apr. 20, 2023, which is incorporated herein by reference in its entirety, and additionally claims priority from European Application No. 22169540.6, filed Apr. 22, 2022, which is also incorporated herein by reference in its entirety.

### TECHNICAL FIELD

Embodiments of the present application relate to the field of wireless communication, and more specifically, to sidelink unlicensed channel access.

### BACKGROUND OF THE INVENTION

FIG. 1 is a schematic representation of an example of a terrestrial wireless network 100 including, as is shown in FIG. 1(a), a core network 102 and one or more radio access networks RAN1, RAN2, . . . . RANN. FIG. 1(b) is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANn may include more or less such cells, and RANn may also include only one base station. FIG. 1(b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1(b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1(b) by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard. In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each other, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

In a wireless communication system as described above, such as LTE or New Radio (5G), a number of devices communicating over the sidelink is constantly growing, such that an available bandwidth or available resources are shared by more and more devices.

Therefore, there is the need for enhancements and improvements with respect to available bandwidth or available resources.

It is noted that the information in the above section is only for enhancing the understanding of the background of the invention and therefore it may contain information that does not form conventional technology and is already known to a person of ordinary skill in the art.

### SUMMARY

An embodiment may have a transceiver of a 4th or 5th generation mobile communication system, wherein the transceiver is configured to operate in a sidelink mode, wherein the transceiver is configured, in the sidelink mode, to transmit or receive signals using radio resources in an unlicensed band, wherein the unlicensed band is one out of the following unlicensed bands:
the 2.4 GHz band,
the 5 GHz band with the exception of the intelligent transport system, ITS, band,
the 6 GHz band,
the 60 GHz band,
the 57 GHz to 71 GHz band,
unlicensed bands in FR2 range,

wherein the transceiver is configured, when using the radio resources for transmitting a signal, to transmit a fifth control signal, the fifth control signal indicating when the radio resources will be free and/or a remaining time of the channel occupancy time, COT, wherein the transceiver is configured to transmit the fifth control signal only to those transceivers of the wireless communication system that are located within a predefined distance to the transceiver or that have a reference signal received power, RSRP, above a predefined threshold.

According to another embodiment, a method for operating a transceiver of a 4th or 5th generation mobile communication system may have the steps of: operating the transceiver in a sidelink mode, transmitting or receiving signals using radio resources in an unlicensed band, wherein the unlicensed band is one out of the following unlicensed bands:
the 2.4 GHz band,
the 5 GHz band with the exception of the intelligent transport system, ITS, band,
the 6 GHz band,
the 60 GHz band,
the 57 GHz to 71 GHz band,
unlicensed bands in FR2 range,

transmitting a fifth control signal when using the radio resources for transmitting a signal, the fifth control signal indicating when the radio resources will be free and/or a remaining time of the channel occupancy time, COT, wherein the fifth control signal is transmitted only to those transceivers of the wireless communication system that are located within a predefined distance to the transceiver or that have a reference signal received power, RSRP, above a predefined threshold.

Another embodiment may have a transceiver of a 4th or 5th generation mobile communication system, wherein the transceiver is configured to operate in a sidelink mode, wherein the transceiver is configured, in the sidelink mode, to transmit or receive signals using radio resources in an unlicensed band, wherein the unlicensed band is one out of the following unlicensed bands:
the 2.4 GHz band,
the 5 GHz band with the exception of the intelligent transport system, ITS, band,
the 6 GHz band,
the 60 GHz band,
the 57 GHz to 71 GHz band,
unlicensed bands in FR2 range,

wherein the transceiver is configured, when transmitting a signal on the radio resources that extends over two or more slots, to transmit a dummy symbol on a guard symbol of a respective slot in order to block the radio resources.

According to another embodiment, a method for operating a transceiver of a 4th or 5th generation mobile communication system may have the steps of: operating the transceiver in a sidelink mode, transmitting or receiving signals using radio resources in an unlicensed band, wherein the unlicensed band is one out of the following unlicensed bands:
the 2.4 GHz band,
the 5 GHz band with the exception of the intelligent transport system, ITS, band,
the 6 GHz band,
the 60 GHz band,
the 57 GHz to 71 GHz band,
unlicensed bands in FR2 range,

transmitting a dummy symbol when transmitting a signal on the radio resources that extends over two or more slots, wherein the dummy symbol is transmitted on a guard symbol of a respective slot in order to block the radio resources.

Still another embodiment may have a non-transitory digital storage medium having stored thereon a computer program for performing the method for operating a transceiver as mentioned above when the computer program is run by a computer.

### BRIEF DESCRIPTION OF THE DRAWINGS

Embodiments of the present invention are described herein making reference to the appended drawings.

FIG. 1a shows a schematic representation of an example of a wireless communication system;

FIG. 1b is a schematic representation of an example of a radio access network RANn that may include one or more base stations;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 shows a schematic representation of a conventional access to unlicensed bands according to ETSI with a slot time of 9 μs;

FIG. 7 shows a schematic representation of a conventional sidelink channel access using a sensing window of 100 ms to 1100 ms for selecting resources within a 32 ms selection window;

FIG. 8 is a schematic representation of a wireless communication system comprising a transceiver, like a base station or a relay, and a plurality of communication devices, like UEs;

FIG. 9 shows a schematic representation of a sub-slot based data transmission of a UE using radio resources of an unlicensed channel, in accordance with an embodiment;

FIG. 10 shows a schematic representation of a sub-slot based data transmission on radio resources of an unlicensed channel performed by a UE using a cyclic prefix extension, in accordance with an embodiment;

FIG. 11 shows in a diagram an occupation of resources of the wireless communication network during a sensing window of the single shot sensing based on which the transceiver determines a sensing information describing free resources and/or occupied resources in a following transmission window, in accordance with a first exemplary embodiment;

FIG. 12 shows in a diagram an occupation of resources of the wireless communication network during a sensing window of the single shot sensing based on which the transceiver determines a sensing information describing free resources and/or occupied resources in a following transmission window, in accordance with a second exemplary embodiment;

FIG. 13 shows in a diagram an occupation of resources of the wireless communication network during a sensing window of the single shot sensing based on which the transceiver determines a sensing information describing free resources and/or occupied resources in a following transmission window, in accordance with a third exemplary embodiment;

FIG. 14 shows in a diagram an occupation of resources of the wireless communication network during a sensing window of the single shot sensing based on which the transceiver determines a sensing information describing free resources and/or occupied resources in a following reservation window, wherein there is a gap between the sensing window and the reservation window; and

FIG. 15 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

As indicated above, a number of devices communicating over the sidelink is constantly growing, such that there is the need for enhancements and improvements with respect to available bandwidth or available resources.

Currently, sidelink access is only standardized for licensed and intelligent transport system (ITS) bands.

However, unlicensed bands, for example, at 2.4 GHZ, 5 GHZ, 6 GHZ and 60 GHz provide the possibility that wireless technologies can operate without the need of first obtaining a license for the regulatory body. Further, it is a way to extend spectrum and thus gain more bandwidth without an extra license and the associated cost. Nonetheless, the devices operating in such bands need to fulfill regulations specific to these bands. Those typically include, for example, one or more out of:
low transmission power and limited Power Spectral Density (PSD);
mechanisms to protect incumbents, such as Dynamic Frequency Selection (DFS) or Automated Frequency Coordination (AFC);
deployment limitations, such as restriction to indoor usage or antenna directivity and azimuth;
some spectrum etiquette, or contention mechanism.

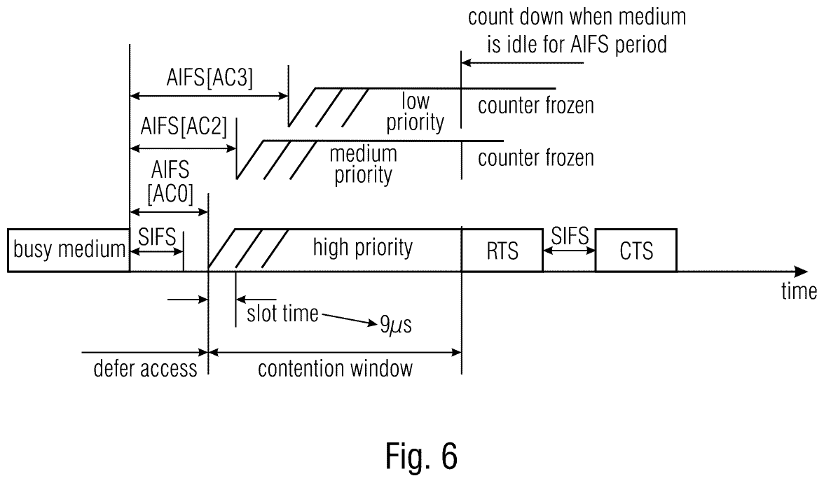

One of the most restrictive regulations regarding channel access mechanism is that ETSI mandates the usage of Listen-before-Talk (LBT) in several bands [1]. LBT has been present early on 802.11 standards and the regulation has been adopted from 802.11e QoS framework, also known as eDCA (enhanced Distributed Channel Access). Therefore, akin to 802.11e the ETSI regulation defines four access priority classes that differ in how long the channel has to be evaluated as free before transmission is possible and how long the channel can be accessed, aka channel occupancy time (COT). In addition, the ETSI regulations define a second type of channel access mechanism, namely Frame Based Equipment (FBE). FBE starts transmissions at regular intervals, evaluating if the channel is free for a single slot (9 μs) before transmitting (see FIG. 6). If the channel is not free, the transmission is skipped for that frame. The frame can be configured between 1 ms and 10 ms, and shall not be adapted more frequently than every 200 ms. Also, the frame can be at most be occupied by 95% because a gap of at least 5% duration of the frame needs to be introduced. Also, the gap needs to be at least 100 μs.

The channel access mechanism of NR-U [2] takes into consideration the ETSI regulations and specifies several cases of downlink and uplink transmission, as well as COT sharing between uplink and downlink. In general, any gap shorter than 16 us is considered a non-interruption while larger gaps involve evaluating the channel again.

In contrast to the above described channel access on unlicensed bands, for channel access in sidelink, 5G/NR has two different modes of resource allocation:
mode 1, where gNB allocates the radio resources, and.
mode 2, where the UE selects radio resources autonomously, based on sensing measurement.

Mode 1 operation supports dynamic and configured scheduling of grants. The dynamic grant is the conventional method where one PDCCH triggers one transmission. The configured grant is for semi-persistent scheduling and is further subdivided into two types of operation:
Type 1: a sidelink configured grant is set or stopped via RRC signaling. The UE can simply use the resources allocated on the configured grant.
Type 2: the configured grant is activated and deactivated via DCI signaling.

Both, in mode 1 and mode 2, sidelink operation defines resource pools for transmission and reception and optionally an additional resource pool that is only used in exceptional cases, such as radio link failures. Basically, the resource pool limits the frequency and time resources that are used for sidelink operation.

Mode 2 channel access is based on UE's continuous sensing and announcing a transmission in the current slot and up to two resource reservations for further transmissions, for example anticipated retransmissions, within the next 31 slots on SCI. Other UEs, which need to select resources, observe the resource reservations during a sensing window. Based on the observed reservations and access priority, the physical layer of the UE considers 20, 35 or 50% of the best resource candidates from a selection window and reports the candidate radio resource to the MAC layer. Finally, the resources are selected randomly from candidate resources by the MAC layer.

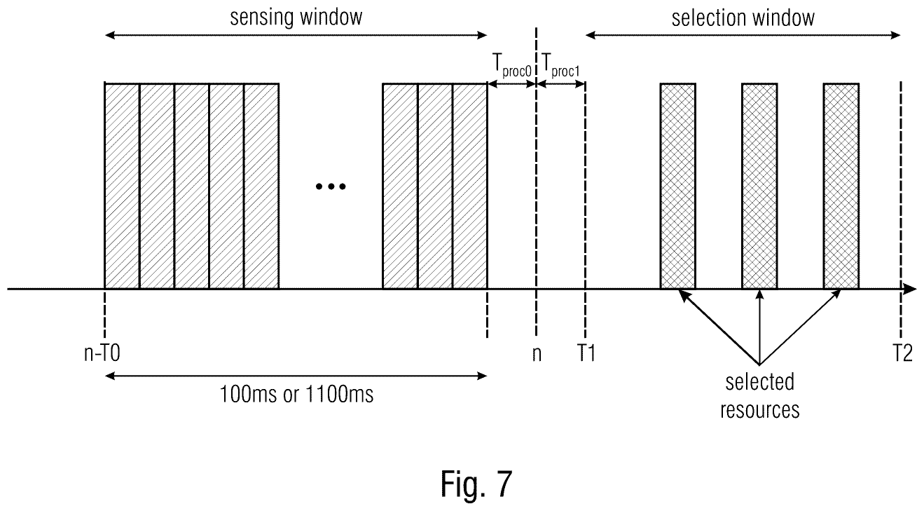

The time scales involved in sidelink channel access are much larger than in unlicensed band access (see FIG. 7). Namely, the sensing window can be 100 ms or 1100 ms depending on traffic type. Also, for a periodic traffic the resource reservation period may be configured from 0 to 100 ms, or from 100 ms to 1000 ms in any step size depending of periodicity of traffic. For aperiodic traffic the radio resources are selected within a selection window bounded to 32 ms for initial transmission and retransmission. Such time scales are completely incompatible with the time scales of the unlicensed band (slots of μs) and the concept of resource reservation is also not possible in unlicensed because it would not be subject to the channel access procedure based on LBT according to the underlying principles of Wi-Fi.

Therefore, the resource allocation for sidelink needs to be revised for the unlicensed band.

Subsequently described embodiments show how sidelink communication (e.g., in 5G NR or LTE) can be supported on unlicensed bands. Thereby, some of the embodiments solve the issue of how sidelink (e.g., in 5G NR or LTE) can be transmitted in unlicensed bands, focusing on the channel access and corresponding resource allocation.

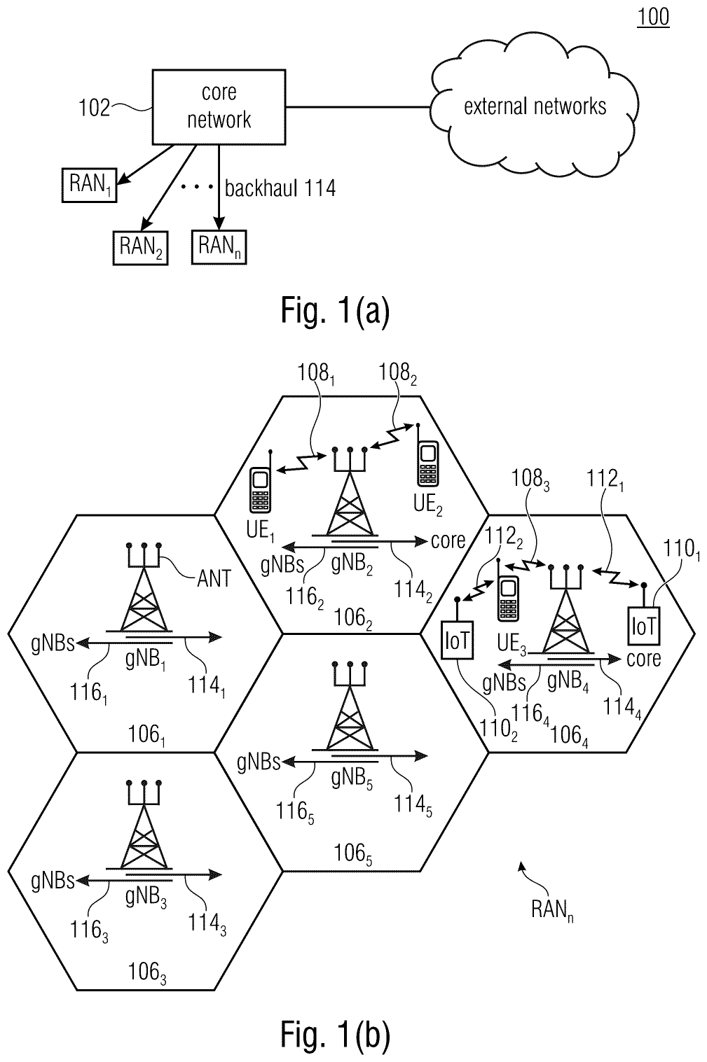

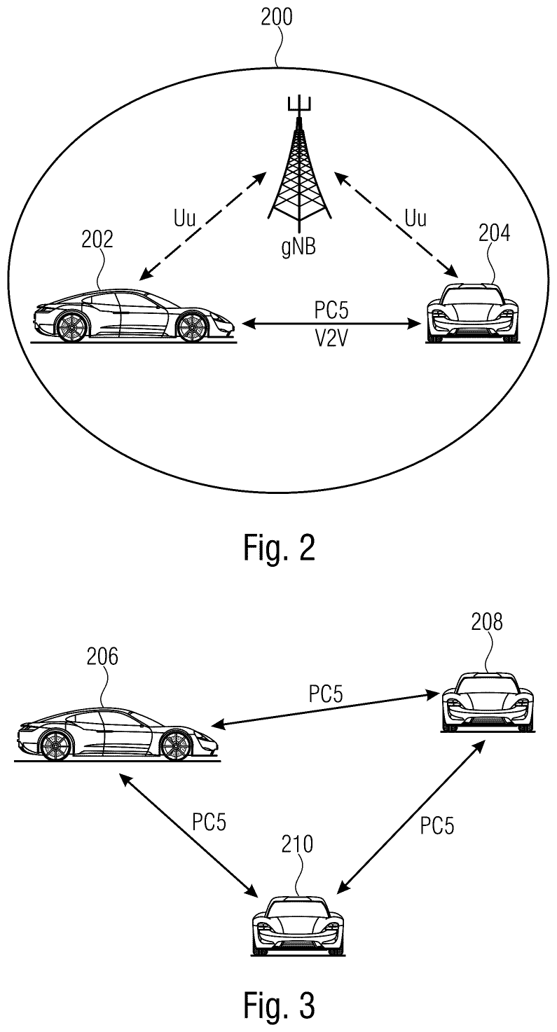

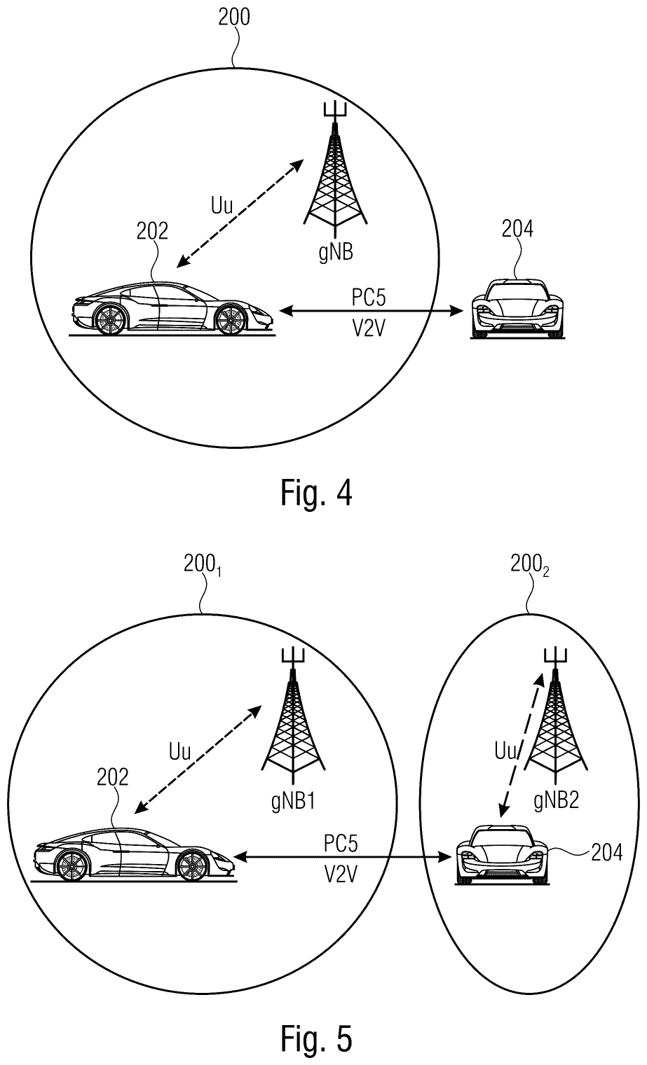

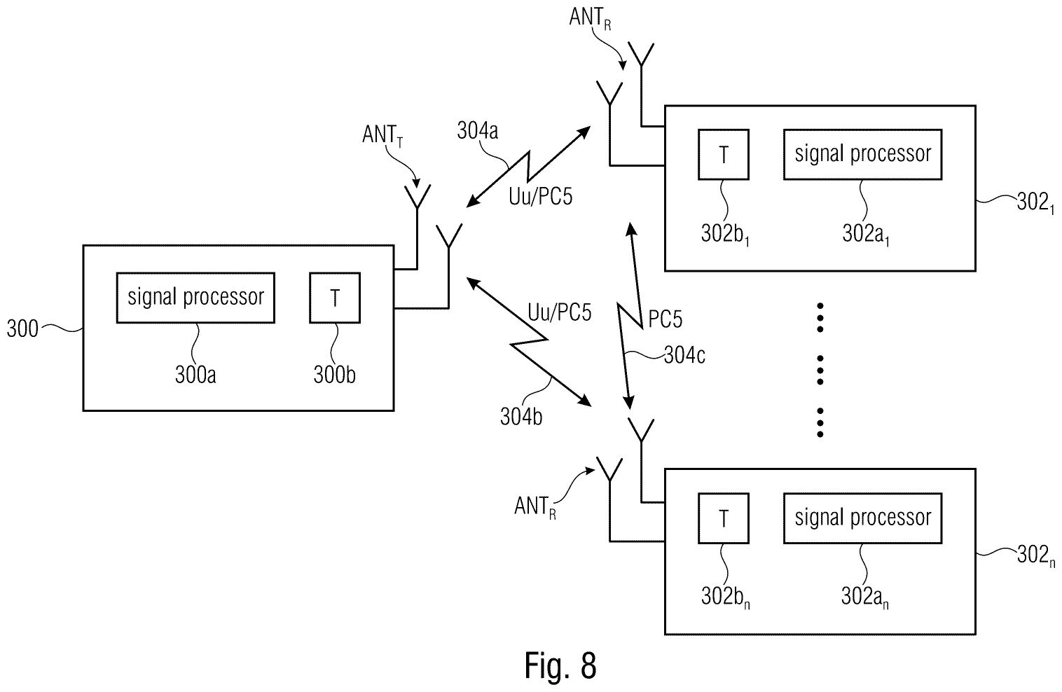

Embodiments of the present invention may be implemented in a wireless communication system or network as depicted in FIGS. 1 to 5 including a transceiver, like a base station, gNB, or relay, and a plurality of communication devices, like user equipment's, UEs. FIG. 8 is a schematic representation of a wireless communication system comprising a transceiver 300, like a base station or a relay, and a plurality of communication devices 302₁ to 302ₙ, like UEs. The UEs might communicated directly with each other via a wireless communication link or channel 304c, like a radio link (e.g., using the PC5 interface). Further, the transceiver and the UEs 302 might communicate via wireless communication links or channels 304a, 304b, like radio links (e.g., using the Uu interface). The transceiver 300 might include one or more antennas ANT or an antenna array having a plurality of antenna elements, a signal processor 300a and a transceiver unit 300b. The UEs 302₁ to 302ₙ might include one or more antennas ANT or an antenna array having a plurality of antennas, a signal processor 302a₁ to 302aₙ, and a transceiver unit 302b₁ to 302bₙ. The base station 300 and/or the one or more UEs 302 may operate in accordance with the inventive teachings described herein.

Embodiments provide a transceiver [e.g., UE] of a 4th or 5th generation mobile communication system [e.g., 4th or 5th generation cellular network], wherein the transceiver is configured to operate in a sidelink mode [e.g., 5G/NR mode 1 or LTE mode 3; or 5G/NR mode 2 or LTE mode 4] [e.g., in which radio resources for a sidelink communication are (pre-) configured by the wireless communication system or allocated by a base station of the wireless communication system; or allocated or scheduled autonomously by the transceiver], wherein the transceiver is configured, in the sidelink mode, to transmit or receive signals using radio resources [e.g., a resource pool] in an unlicensed band, wherein the unlicensed band is one out of the following unlicensed bands:
the 2.4 GHz band,
the 5 GHz band with the exception of the intelligent transport system, ITS, band, [e.g., 3GPP band n47],
the 6 GHz band, [e.g., 3GPP bands n96 and/or n102],
the 60 GHz band,
the 57 GHz to 71 GHz band,
unlicensed bands in FR2 range [e.g., 24250 MHz-52600 MHz].

In embodiments, the transceiver is configured to use the radio resources [e.g., the resource pool] for transmitting or receiving signals over the Uu interface and/or the PC5 interface.

In embodiments, the radio resources are defined by a resource pool [e.g., a dynamic resource pool].

In embodiments, the transceiver is configured to receive a first control signal [e.g., from the base station], the first control signal indicating a start and/or an end of a period during which the radio resources [e.g., the resource pool] can be used by the transceiver for transmitting and/or receiving signals, wherein the transceiver is configured to use the radio resources [e.g., the resource pool] for transmitting and/or receiving signals during the period indicated by the first control signal.

In embodiments, the radio resources [e.g., the resource pool] are available/active during one or more preconfigured periods [e.g., during which the which radio resources [e.g., the resource pool] can be used by the transceiver for transmitting and/or receiving signals], wherein the transceiver is configured to perform at a start of a respective period a clear channel assessment, CCA, procedure [e.g., listen before talk] in order to determine whether the radio resources [e.g., the resource pool] is free [e.g., not used by other communication systems operating in the same unlicensed band], wherein the transceiver is configured to use the radio resources [e.g., the resource pool] for transmitting and/or receiving signals only when the radio resources [e.g., the resource pool] are free.

In embodiments, the transceiver is configured to transmit, when the radio resources [e.g., the resource pool] are free, a second control signal to one or more other transceivers of the wireless communication system, the second control signal indicating that the resource pool is used by the wireless communication system during the respective period.

In embodiments, the radio resources [e.g., the resource pool] are available/active during one or more preconfigured periods [e.g., during which the radio resources [e.g., the resource] pool can be used by the transceiver for transmitting and/or receiving signals], wherein the transceiver is configured to receive a third control signal from another transceiver of the wireless communication system, the third control signal indicating whether the radio resources [e.g., the resource pool] are used by the wireless communication system during a respective period [e.g., indicating whether the resource pool is free], wherein the transceiver is configured to use the radio resources [e.g., the resource pool] for transmitting and/or receiving signals only when the third control signals indicates that the radio resources [e.g., the resource pool] is used by the wireless communication system during a respective period.

In embodiments, the transceiver is configured to perform a single-shot-sensing on or more resources of the radio resources [e.g., the resource pool] prior to transmitting a signal to another transceiver of the wireless communication system, in order to obtain a sensing information, wherein the transceiver is configured to determine, for transmitting the signal, a set of candidate resources out of the radio resources [e.g., the resource pool] based on the sensing information, wherein the transceiver is configured to select, for transmitting the signal, resources out of the set of candidate resources and to transmit the signal using the selected resources.

In embodiments, the radio resources [e.g., the resources of the resource pool] are accessed in the time domain on a slot basis, wherein the transceiver is configured to select the resources out of the set of candidate resources for transmitting the signal and to be ready to transmit the signal until an end of a last occurring slot of a sensing window used for said single-shot-sensing.

In embodiments, the transceiver is configured to receive a fourth control signal [e.g., SCI] from another transceiver of the wireless communication system that is currently using the radio resources [e.g., the resource pool], the fourth control signal indicating when the radio resources [e.g., the resource pool] are free and/or a remaining time of the channel occupancy time, COT.

In embodiments, the transceiver is configured, when using the radio resources [e.g., the resource pool] for transmitting a signal, to transmit a fifth control signal [e.g., SCI], the fifth control signal indicating when the radio resources [e.g., the resource pool] will be free and/or a remaining time of the channel occupancy time, COT.

In embodiments, the transceiver is configured to transmit the fifth control signal only to those transceivers of the wireless communication system that are located within a predefined distance to the transceiver or that have a reference signal received power, RSRP, above a predefined threshold.

In embodiments, the remaining channel occupancy time is signaled by means of an entry to a list or a number of slots or symbols.

In embodiments, the remaining channel occupancy time, COT, is signaled by means of a 2^{nd} stage sidelink control information.

In embodiments, the 2^{nd} stage sidelink control information comprises one or more out of the following information:
a priority,
a time resource,
a periodicity of transmission,
a frequency,
a communication range,
a zone or geographical area,
a countdown value.

In embodiments, the radio resources are first radio resources [e.g., the resource pool is a first resource pool], wherein the transceiver is configured to transmit transport block using the first radio resources in case that a size of the transport block is higher than a threshold, and to transmit the transport block using second radio resources [e.g., a second resource pool] in case that the size of the transport block is equal to or smaller than the threshold.

In embodiments, the transceiver is configured to perform blind retransmissions on different frequencies on the radio resources [e.g., the resource pool] in order to fulfill a minimum occupied channel bandwidth, OCB, of the unlicensed band.

In embodiments, the transceiver is configured to transmit a signal using a sub-channel of the radio resources [e.g., the resource pool].

In embodiments, the transceiver is configured to select resources out of the radio resources [e.g., the resources of the resource pool] for transmitting a signal such that a time gap between a last occupied resource of the radio resources [e.g., the resource pool] [e.g., occupied by the transceiver or another transceiver of the wireless communication system] and a first resource used for transmission is smaller than a predefined value [e.g., 16 μs].

In embodiments, the transceiver is configured to perform a clear channel assessment, CCA, procedure [e.g., listen before talk] in order to determine whether the radio resources [e.g., the resource pool] are free in case that a time gap between a last occupied resource of the radio resources [e.g., the resource pool] [e.g., occupied by the transceiver or another transceiver of the wireless communication system] and a first resource scheduled to be used by the transceiver for transmitting a signal is greater than a predefined value [e.g., 16 μs], wherein the transceiver is configured to use the radio resources [e.g., the resource pool] for transmitting and/or receiving signals only when the resource pool is free.

In embodiments, resources for transmitting a signal are allocated to the transceiver autonomously or by a base station of the wireless communication system on a sub-slot or mini slot basis [e.g., such that the transceiver uses a next possible symbol of a slot for transmitting a signal].

In embodiments, the transceiver is configured to use, for transmitting a signal, a cyclic prefix extension in order to start transmission of a signal before OFDM symbol boundaries.

In embodiments, the transceiver is configured, when transmitting a signal on the radio resources [e.g., the resource pool] that extends over two or more slots, to transmit a dummy symbol on a guard symbol of a respective slot in order to block the radio resources [e.g., the resource pool] [e.g., to avoid that other communication systems start using the radio resources [e.g., the resource pool]].

In embodiments, the transceiver is configured to start a transmission of a signal as soon as [e.g., one or two symbols immediately after] a clear channel assessment, CCA, procedure indicates that a channel is free [e.g., independent on slot boundaries; e.g. on a sub-slot or mini slot basis], wherein the transceiver is configured to start the transmission of the signal applying a cyclic prefix extended by a time between the time the channel became free [or a time of a start of the transmission] and a slot boundary.

In embodiments, the transceiver is configured to receive a sixth control signal from a base station of the wireless communication system, the sixth control signal comprising a semi static channel access information indicating that a channel of the radio resources [e.g., the resource pool] is to be accessed based on a semi static period basis, wherein the transceiver is configured to transmit a signal on the radio resources [e.g., the resource pool] in dependence on the semi static channel access information.

Further embodiments provide a base station [e.g., eNB] of a 4th or 5th generation mobile communication system [e.g., 4th or 5th generation cellular network], wherein the base station is configured to transmit or receive signals [e.g., data and/or control information] to or from one or more transceivers of the wireless communication system that operate in a sidelink mode, wherein the base station is configured to transmit or receive the signals using the radio resources [e.g., a resource pool] in an unlicensed band, or wherein the base station is configured to transmit a control signal to the one or more transceivers, the control signal controlling the one or more transceivers to use the radio resources [e.g., a resource pool] in an unlicensed band for sidelink communication, wherein the unlicensed band is one out of the following unlicensed bands:
the 2.4 GHz band,
the 5 GHz band with the exception of the intelligent transport system, ITS, band, [e.g., 3GPP band n47],
the 6 GHz band, [e.g., 3GPP bands n96 and/or n102],
the 60 GHz band,
the 57 GHz to 71 GHz band,
unlicensed bands in FR2 range [e.g., 24250 MHz-52600 MHz].

Further embodiments provide a method for operating a transceiver [e.g., UE] of a 4th or 5th generation mobile communication system [e.g., 4th or 5th generation cellular network], the method comprising: operating the transceiver in a sidelink mode [e.g., 5G/NR mode 1 or LTE mode 3; or 5G/NR mode 2 or LTE mode 4] [e.g., in which radio resources for a sidelink communication are (pre-) configured by the wireless communication system or allocated by a base station of the wireless communication system; or allocated or scheduled autonomously by the transceiver]; transmitting or receiving signals [e.g., data and/or control information] using radio resources [e.g., a resource pool] in an unlicensed band, wherein the unlicensed band is one out of the following unlicensed bands:
the 2.4 GHz band,
the 5 GHz band with the exception of the intelligent transport system, ITS, band, [e.g., 3GPP band n47],
the 6 GHz band, [e.g., 3GPP bands n96 and/or n102],
the 60 GHz band,
the 57 GHz to 71 GHz band,
unlicensed bands in FR2 range [e.g., 24250 MHz-52600 MHZ].

Further embodiments provide a method for operating a base station [e.g., eNB] of a 4th or 5th generation mobile communication system [e.g., 4th or 5th generation cellular network], transmitting or receiving signals [e.g., data and/or control information] to or from one or more transceivers of the wireless communication system that operate in a sidelink mode, wherein the signals are transmitted or received using radio resources [e.g., a resource pool] in an unlicensed band, or wherein the method comprises transmitting a control signal to the one or more transceivers, the control signal controlling the one or more transceivers to use radio resources [e.g., a resource pool] in an unlicensed band for sidelink communication, wherein the unlicensed band is one out of the following unlicensed bands:
the 2.4 GHz band,
the 5 GHz band with the exception of the intelligent transport system, ITS, band, [e.g., 3GPP band n47],
the 6 GHz band, [e.g., 3GPP bands n96 and/or n102],
the 60 GHz band,
the 57 GHz to 71 GHz band,
unlicensed bands in FR2 range [e.g., 24250 MHz-52600 MHz].

Embodiments described herein solve the problem of the channel access of sidelink not being compatible with the rules of unlicensed band, since the timescales are completely different. Thereby, embodiments take into account regulatory issues and other systems (e.g., operating on the same unlicensed bands).

Subsequently described embodiments provide one or more out of
a dynamic resource pool activation/de-activation,
a faster sidelink sensing (single-shot sensing),
UE-to-UE COT sharing with a special remaining time mechanism,
modifications to sidelink resource allocation to fulfill minimum occupied bandwidth regulations and avoiding time gaps,
once the channel is accessed, transmission with extended Cyclic prefix to occupy the channel immediately.

Subsequently, embodiments of the present invention are described in further detail.

### 1. Usage of Unlicensed Spectrum

While for sidelink mode 2 there is only one way, namely to use the unlicensed spectrum, for PC5, in accordance with embodiments, there are more options for mode 1 since the Uu interface can be used for control signaling (PDCCH) in addition to the PC5 interface:
Uu in licensed and PC5 in unlicensed band other than band n47. In this option the PC5 interface may apply the underlying principles of Wi-Fi.
Uu in unlicensed and PC5 in band n47 or n38. Though n47 is unlicensed the underlying principles of Wi-Fi do not apply in both of these bands, since if they are used for V2X it is exclusively for V2X.
Uu and PC5 in unlicensed band other than band n47. Due to half-duplex operation the Uu and PC5 can even share the same unlicensed carrier.

### 2. Dynamic Resource Pool

When the sidelink (PC5) is operating in unlicensed band the channel is not always available nor it can be planed that the channel will be available at regular intervals.

Therefore, in embodiments, the gNB may define a dynamic resource pool which can operate with either of two basic principles:
The gNB signals the start and end of the period which the resource pool is active.
The dynamic resource pool starts at a fixed period, where an entire resource pool period may be skipped if the channel is not available.

Thereby, a UE may receive the configuration from the network through RRC or DCI.

Further detailed embodiments of operation are discussed in the following subsections.

2.1 Dynamic Resource Pool with Asynchronous Start

If the Uu interface is operated in the same unlicensed band as PC5, in embodiments, the gNB may be configured to control if a particular COT is shared for PC5 or used only for Uu. If Uu is instead on licensed band, and PC5 is in unlicensed, the UEs may not need to listen to the unlicensed band all the time. In either case, the gNB can inform the UEs via signaling (e.g., RRC or DCI) that the unlicensed resource pool is about to be resumed/activated.

In embodiments, a timer can be included in the signaling to define for how long the resource pool will be active or a second signal can pause/de-activate the resource pool. In either case the COT are respected. An offset may be included to indicate at which point the pool is resumed.

In embodiments, device performing LBT on unlicensed band can be the gNB, but not necessarily. It could be any device which is able to inform the gNB, so that in turn the gNB can inform UEs. Examples are the UEs or a NR-U gNB. In particular, if Uu is operating in licensed band, once the resource pool is activated the UEs may need some time to retune. If this time exceeds, for example, 16 us or 25 μs, the UEs can evaluate the channel again with a short CCA (e.g., LBT type 2A or 2B—16 us or 25 μs) before starting transmission.

Alternatively, when a UE exceeds the time configured for sensing, a UE can be configured or controlled (e.g., mandated) to perform puncturing or rate matching to reduce the PSSCH to be fitted to the remaining identified free time. The puncturing or rate matching can be configured/allowed by RRC or DCI within an RP, or UE may decide based on its implementation when it is allowed or configured within RP.

In embodiments, the activation of a resource pool may be combined with the activation of configured grant (e.g., type 2 grant in sidelink).

2.2 Dynamic Resource Pool with CCA Evaluation

The dynamic resource pool is planned to be available at regular intervals, but if the channel is busy, in embodiments, the usage of the resource pool can be skipped for one resource pool period. The UEs which transmit at the beginning of the resource pool period, perform a CCA before the period starts to evaluate if the channel is free for the time given by the band regulation (e.g., LBT type 2B). This regulated time may be different depending on whether the radio resource pool can be classified as FBE (frames of 1 to 10 ms) or not. If the radio resource pool has a short period, dynamic channel access (LBE) regulation may apply and the CCA can involve the complete LBT for LBE (LBT type 1).

In embodiments, the remaining UEs (e.g., receiving UEs or other transmit UEs not allocated to the beginning of resource pool) may either evaluate the channel prior to the resource pool period start or read the SCIs at the beginning of the resource pool to determine if that resource pool period is valid. If the channel is busy, no transmission should occur, and UEs can sleep to save battery until the next evaluation.

In embodiments, this configuration of dynamic resource pools can also be used on mode 2. In this case the “resource reservation” of mode 2 should be understood as a “resource reservation as long as the channel was acquired for sidelink”.

### 3. Faster Sidelink Resource Allocation

In the unlicensed band contention occurs at microsecond's timescale. In sidelink mode 2, the sensing window and resource selection occur on milliseconds or even a full second timescale. These different timescales are somewhat incompatible. Therefore, the sidelink channel evaluation and selection shall be made faster. An embodiment for making faster selections in sidelink is described below in section 9. This embodiment can be combined with the techniques described in the other sections. In particular, the presence of a countdown on SCI can be beneficial for different reasons, such as, for example, COT sharing (see section 4) and microsleeping until end of COT when a new LBT can be started.

### 4. Sidelink COT Sharing

In embodiments, a resource usage countdown and the remaining COT can be added to the SCI. By adding resource usage countdown and the remaining COT in SCI, different UEs can reuse the same channel occupancy for transmission. In that way, a UE reading SCI can know when a resource will be free and for long it could still be used.

Such UE-to-UE COT sharing is only beneficial if the UEs are close enough to each other. Otherwise, other systems on vicinity will wrongly deem the channel as free or occupied (hidden-node and exposed-node problems). In order to avoid such situation, in embodiments, UE-to-UE COT sharing can be limited to the case where the sidelink RSRP is above a certain threshold and/or the distance between Sidelink UEs is within a certain range.

If there are multiple UEs waiting to take part on a shared COT, in embodiments, other mechanisms of resolution may be applied, such as, for example, regular sidelink resource allocation and reservation. The priority may be also taken into account.

In embodiments, a gNB-initiated COT may be signaled to SL-capable UE in mode 1 and then this UE informs other SL-capable UEs of the remaining COT via SCI signaling on SL. The remaining COT may be signaled as, for example,
an entry to a list as for NR-U, for example, where the co-DurationList is an RRC List where each entry has a value from 0 to 1120 symbols (TS 38.331, SlotFormatIndicator IE); and/or
a number of slots or symbols (“countdown”).

### 4.1 Sidelink COT Sharing Signaling

In embodiments, a UE may share its COT through a second stage SCI with other UEs capable of sidelink communication. For example, it is possible to signal the COT to the other UEs as a advantageous set of radio resources when both communicating UEs can perform Inter-UE coordination.

For this purpose, embodiments define a new second stage SCI, for example, SCI format 2_X, where SCI format 2_X comprises one or more out of the following information:
priority,
time resource,
periodicity of transmission,
frequency,
communication range,
zone or geographical area,
countdown value,

where a UE is allowed to share the COT with other UEs when the COT sharing is configured for the resource pool.

In embodiments, the COT sharing is configured by RRC or DCI.

### 5. Resource Allocation Fulfillment of Minimum OCB

Unlicensed bands often have regulation of minimum Occupied Channel Bandwidth (OCB). This is necessary such that devices on the vicinity can perform energy detection for LBT. In mode 1 the gNB can take care of fulfilling the regulation. In case of mode 2, the sidelink resource allocation shall fulfill the minimum OCB. This can be defined with some rules, such as, for example:
Definition of two resource pools, one on unlicensed band, other in licensed band (or ITS band). Thereby, small transport blocks can be transmitted on licensed band. If the transport block size is higher than a threshold, then transmission can be performed on unlicensed band.
Blind retransmissions on frequency domain until the OCB is fulfilled.

### 6. Gap Avoidance in Time Domain

When selecting resources in time domain any gap larger than 16 us may be perceived by devices in the vicinity as the channel being free. Therefore, transmission gaps should be avoided as much as possible. In mode 1 the gNB may take care of avoiding such gaps, but in mode 2 a different solution may be needed. With respect to existing mode 2 resource allocation, the candidate resource set should first only include resources which are less than 16 us away from occupied resources. If this is not sufficient (e.g., given the transport block size and access priority) the candidate set can be enlarged until the target number of candidates is satisfied. If a UE selects resources which will leave a gap, the UE can only use them after performing a short CCA (e.g., LBT type 2A or 2B—16 μs or 25 μs).

Current resource allocation in SL is based on slots and sub-channels in a resource pool, i.e. there is always a gap until the next start of a slot in case an initial CCA via LBT has been performed. To mitigate this, the sub-slot based resource allocation and cyclic prefix extension may be applied in mode 2 (or possible mode 1).

Embodiments provide sub/mini-slot based resource allocation, i.e. a UE starts transmitting resources in the next possible symbol in a slot
in mode 1, this may be signaled via the gNB via DCI similar to PDSCH mapping type B in Uu and then SCI takes this signaling, and/or
in mode 2, usually all symbols in a slot are assumed to be available for sidelink. In a cell, a SL-TDDConfig can be signaled for mode 1, where only UL symbols can be used for SL, and SL-BWP-Generic-r16 contains the sl-StartSymbol-r16 and sl-Length-Symbols-r16 which can be used for sidelink. To signal an “early start”, this may be signaled in the SCI in the next slot which indicates the starting position in the previous slot (possibly similar to a pre-emption indication).

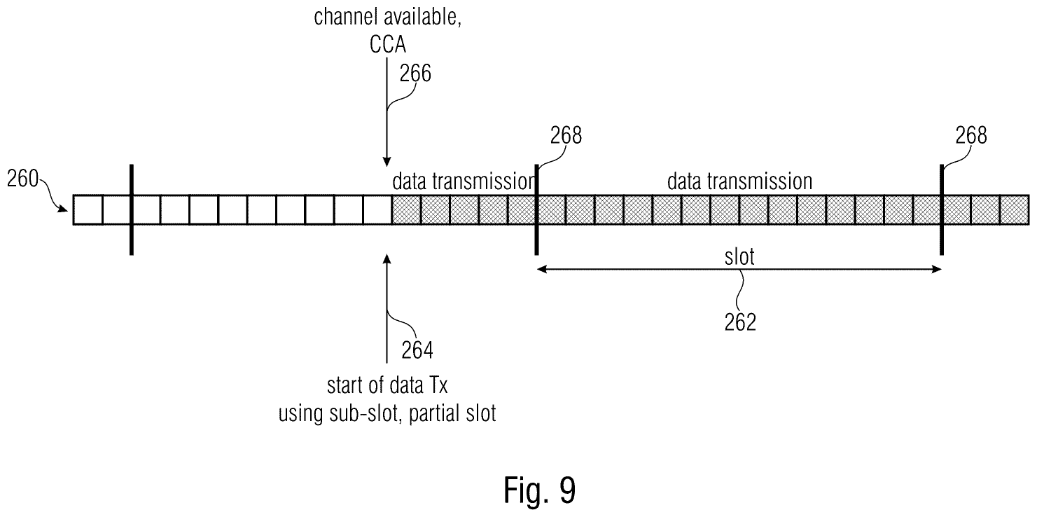

FIG. 9 shows a schematic representation of a sub-slot based data transmission of a UE using radio resources of an unlicensed channel. As in indicated in FIG. 9, radio resources 260 may be grouped on a slot 262 basis, wherein each slot 262 may comprise 14 resources 260 (e.g., symbols), wherein the UE can be configured to start 264 the data transmission immediately after a clear channel assessment, CCA, procedure 266 which indicates that the radio resources 260 are free, for example in the next possible radio resource (e.g., symbol), independent of slot boundaries 268. In other words, FIG. 9 shows a schematic representation of a sub-slot transmission.

### 6.1 Cyclic Prefix Extension

In addition to the above sub-slot based resource allocation, the channel sensing interval may not align with OFDM symbol boundaries. In embodiments, Cyclic Prefix Extension (CPE) can be applied to achieve alignment. In addition, Cyclic Prefix Extension can be beneficial to allow for more time before switching from Rx/DL to Tx/UL. In current 3GPP specs, CPE is configured via RRC as part of the NR-U BWP Configuration

### NR-U

UL CPE (C2, C3) is configured in BWPUplinkDedicated (RRC, 38.331) and 38.211, clause 5.3.1 (table 5.3.1-1).
Signaled in field ChannelAccess-CPext in DCI format 0_0 for scheduling grant: Channel Access Type and CP Extension T_ext: see 38.212, Table 7.3.1.1.1-4.

For mode 1, this may be used as well for SL under gNB control.

For mode 2, CPE can be used to ensure that the gap between transmissions is below 16 or 25 μs, respectively. As mode 2 is based on autonomous resource allocation, no Timing Advance configuration of the gNB is present or used. A UE may choose the amount of CPE it needs based on the CCA and its own timing reference for SL frame/symbol timing to keep the timing gap below 16 or 25 μs. The possibility of performing autonomous CPE may be configured as part of the SL-BWPConfig similar to what is done for NR-U BWP configuration. Additionally, the UE may be configured with this capability/feature, i.e. if it can perform autonomous CPE or not.

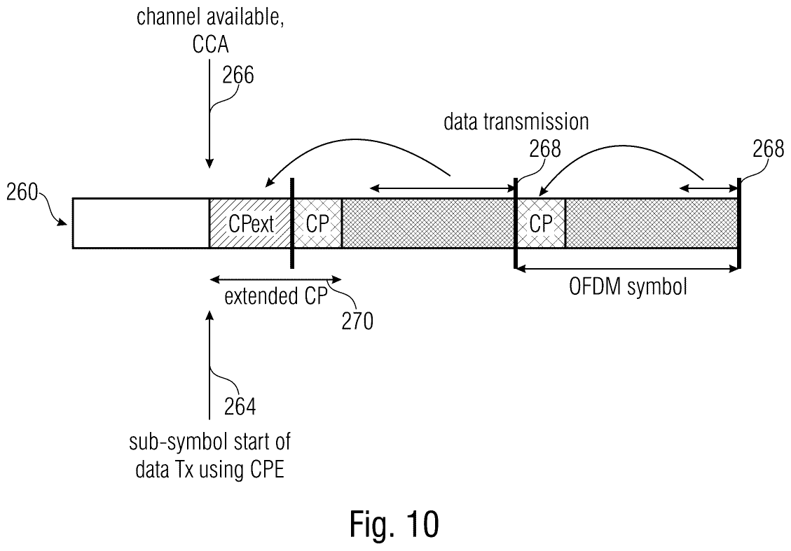

FIG. 10 shows a schematic representation of a sub-slot based data transmission on radio resources of an unlicensed channel performed by a UE using a cyclic prefix extension. Similar to FIG. 9, in FIG. 10 the UE starts 264 the data transmission immediately after a clear channel assessment, CCA, procedure 266 which indicates that the radio resources are free, for example in the next possible radio resource (e.g., symbol), independent of slot boundaries 268, wherein the UE uses a cyclic prefix extension 270, to ensure that a gap between data transmissions is below a predefined value, e.g., below 16 or 25 μs. In other words, FIG. 10 shows a schematic representation of a cyclic prefix extension.

### 6.2 Guard Symbol Usage

Another issue is that the 14th symbol in a slot is used as a guard symbol in SL. A SL UE is not expected to receive in that symbol. Nevertheless, a transmitting UE in an unlicensed band needs to transmit in this guard symbols if its transmission extends beyond one slot and it wants to avoid another short CCA, as the OFDM symbol length exceeds 16 us for SCS up to 60 KHz or 25 us for SCS up to 30 kHz (see table below). As a SL UE is not expected to receive this guard symbol, in embodiments, a “dummy symbol” can be inserted, e.g., by copying either the previous or following symbol of the guard symbol, e.g. an automatic gain control, AGC, symbol.

| | | |
|---|---|---|
| | Symbol length incl. | |
| | cyclic prefix [μsec]: | Slot length |
| | 1^{st} sym in half frame, | (14 sym) |
| Numerology | other symbols | [μsec] |

| | | | |
|---|---|---|---|
| [symbol] [symbol] = 0 | (15 kHz) | 71.875/71.354 | 1000 |
| [symbol] = 1 | (30 kHz) | 36.198/35.677 | 500 |
| [symbol] = 2 | (60 kHz) | 18.359/17.838 | 250 |
| [symbol] = 3 | (120 kHz) | 9.440/8.919 | 125 |

7. Coexistence of Sidelink with Wi-Fi

Compared to the granularity of 16 us for unlicensed channel access the sidelink has slot granularity, that means sidelink transmission can only start at slot boundaries while a COT can start any 16 us of free channel. If several UEs communicate via sidelink, they have to be frame aligned, so that the slot boundaries cannot be shifted freely. This reduces the chances for a sidelink UE to get the channel compared to a Wi-Fi station.

As straightforward solution the sidelink UEs can be regarded as FBE and the corresponding mechanisms applied. This, however, is suboptimal since it does not fully resolve the disadvantage regarding channel access.

Therefore, in embodiments, cyclic prefix (CP) extension is applied. Thereby, a maximum size for the CP extension can be defined which can be a compromise between the probability for successful channel occupation and waste of channel capacity. If the slot boundary approaches in time start LBT beginning at the maximum CP extension before the slot boundary. As soon as the free channel criteria are fulfilled start transmission with a CP extended by the time between the time the channel became free and the slot boundary. Obviously, the chances to obtain the channel are better the longer the CP extension may be. On the other hand this is redundancy that costs correspondingly more channel time.

Since for unlicensed operation the occupied bandwidth of the signal spectrum is meant to be at least a carrier of 20 MHz, this mechanism is not only valid between sidelink UEs and Wi-Fi stations but also among the sidelink UEs.

### 8. Semi-Static Channel Access

Semi-static channel access can be deployed in areas where the absence of other technologies can be guaranteed, e.g. via regulation or in controlled areas. In this case a periodic channel occupancy can be initiated by the gNB on channels within the serving cell (ServingCellConfigCommon, channelAccessMode) every Tx within every two consecutive radio frames (i.e. 2×10=20 ms) where Tx={1, 2, 2.5, 4, 5 10} ms (IE SemiStaticChannelAccessConfig-r16), i.e. COT starts every i*Tx with i=0, 1, 20/Tx-1. The max. COT is Ty=0.95*Tx. The duration Tx=max (0.05*Tx, 100 us) at the end of a period is referred to as idle period. Similarly, from Rel-17 a UE can be configured via SemiStaticChannelAccessConfigUE with a Tu=ue-Period and ue-Offset where a UE can initiate a COT. Tv=0.95*Tu. The offset To=ue-Offset is the number of symbols from the beginning of an even-indexed radio frame to the start of the first period in that radio frame in which the Ue can initiate a COT. The idle period is Tz=max (0.05*Tu, 100 us) at the end of a period.

In both cases, sensing for channel availability can be performed at least in the 9 us before the start of the COT.

This access procedure can also be applied for both SL resource allocation modes: Mode1: gNB can configure cell and UEs with periodic COT opportunities. When Tx=1 ms, Tu=1 ms, this is similar to the existing subframe structure of 1 ms.

For mode 1 and 2, the SL UE senses for channel availability before every COT period and if available, transmits in the COT.

### 9. Sidelink Dynamic Resource Allocation Using Single Shot Sensing Supported by Look-Ahead Information

Subsequently described embodiments allow for improving the sensing procedure of battery operated UEs, for example, VRU-UEs, such as P-UEs. Further, subsequently described embodiments allow reducing or even (minimizing) the collision probability and thus improving the reliability and latency in highly congested scenarios, and/or for improving the efficiency of the resource pool usage, i.e. channel capacity.

In embodiments, the transceiver is configured to perform a single-shot-sensing on resources of the sidelink [e.g., radio resources of the unlicensed band] prior to a sidelink transmission to another transceiver or multiple other transceivers of the wireless communication system, in order to obtain a sensing information, wherein the transceiver is configured to determine, for said sidelink transmission, a set of candidate resources [e.g., one or more candidate resource elements] out of the resources of the sidelink based on the sensing information, wherein the transceiver is configured to select, for said sidelink transmission, resources out of the set of candidate resources and to perform said sidelink transmission using the selected resources, wherein the resources of the sidelink are accessed in the time domain on a slot basis, wherein the transceiver is configured to select the resources out of the set of candidate resources for said sidelink transmission and to be ready to perform said sidelink transmission until an end of a last occurring [e.g., most recent] slot of a sensing window used for said single-shot-sensing.

In embodiments, the sensing window of the single-shot-sensing extends over a single slot.

In embodiments, the sensing window of the single-shot-sensing extends over a plurality of slots [e.g., two or more slots] immediately following each other.

In embodiments, the transceiver is configured to start the sidelink transmission in a slot immediately following the last slot of the sensing window.

In embodiments, the set of candidate resources lay within a transmission window, wherein a first occurring slot of the transmission window immediately follows the last slot of the sensing window.

In embodiments, the transmission window extends over a single slot.

In embodiments, the transmission window extends over a plurality of slots [e.g., two or more slots] immediately following each other.

In embodiments, the sensing information obtained by performing the single-shot-sensing completely describes all resources of the transmission window that are reserved by other transceivers of the wireless communication network.

In embodiments, the set of candidate resources lay within a reservation window, wherein there is a time gap between the sensing window and the reservation window.

In embodiments, a length of the sensing window depends on a length of the gap.

In embodiments, the transceiver is configured to perform the single-shot-sensing by means of receiving and decoding sidelink control information transmitted by other transceivers of the wireless communication network in the slots of the sensing window.

In embodiments, the sidelink control information transmitted in a respective slot comprises a resource occupation signaling information signaling [e.g. a number of] slots immediately following the respective slot that are occupied by another transceiver of the wireless communication system.

In embodiments, the sidelink control information transmitted in a respective slot comprises a resource reservation signaling information signaling slots and/or sub-channels reserved by another transceiver of the wireless communication system.

In embodiments, the transceiver is configured to complete the decoding of the sidelink control information until the end of the last occurring [e.g., most recent] slot of the sensing window.

In embodiments, the transceiver is configured to exploit a fast decoding of the [e.g., first stage] sidelink control information transmitted by one or more [e.g., all] other transceivers of the wireless communication network decoding [e.g., to perform multiple polar decoding, control information parsing, e.t.c.], such that the decoding of the sidelink control information is completed until the end of the last occurring [e.g., most recent] slot of the sensing window.

In embodiments, the transceiver is configured to perform [e.g. to execute an algorithm that performs] at least one out of [e.g., one, two or all out of]
the single-shot-sensing,
the determining the set of candidate resources, and
the selecting of the resources out of the candidate resources
   in a physical layer [e.g., of the open systems interconnection model].

In embodiments, the set of candidate resources are a set of candidate resource blocks, wherein the selected resources are selected resources blocks, each resource block being defined as a single slot in the time domain and a single sub-channel in the frequency domain.

In embodiments, the transceiver is configured to select, for said sidelink transmission, the resource blocks out of the set of candidate resource blocks dynamically in dependence on the set of candidate resource blocks and a data size of said sidelink transmission, such that the selected resource blocks are distributed over both, two or more slots in the time domain and two or more sub-channels in the frequency domain.

In embodiments, the transceiver is configured to transmit, when transmitting the sidelink transmission, a resource occupation signaling information in each slot that is occupied by the selected resources, the resource occupation signaling information signaling a number of immediately subsequent slots in the time domain that are also occupied by the selected resources.

For example, the transceiver can be configured to transmit, when transmitting the sidelink transmission, resource occupation signaling information in each selected resource block, the resource occupation signaling information signaling a number of selected resource blocks immediately following the respective resource block in the time-domain.

In embodiments, the transceiver is configured to transmit the resource occupation signaling information via the sidelink control information.

In embodiments, the transceiver is a UE.

In embodiments, the transceiver is battery operated.

In embodiments, the transceiver is configured to perform a single-shot-sensing on resources of the sidelink [e.g., radio resources of the unlicensed channel] prior to a sidelink transmission to another transceiver or multiple other transceivers of the wireless communication system, in order to obtain a sensing information, wherein the transceiver is configured to determine, for said sidelink transmission, a set of candidate resources out of the resources of the sidelink based on the sensing information, wherein the transceiver is configured to select, for said sidelink transmission, resources out of the set of candidate resources and to perform said sidelink transmission using the selected resources, wherein the resources of the sidelink are accessed in the time domain on a slot basis, wherein the set of candidate resources lay within a reservation window, wherein there is a time gap between the sensing window and the reservation window.

In embodiments, a length of the sensing window depends on a length W of the reservation window.

In embodiments, the length of the sensing window is one slot shorter than the length W of the reservation window.

In embodiments, the reservation window comprises
a first transmission window zone comprising the candidate resources out of the set of candidate resources determined based on the sensing information,
a gap window zone where no sensing information is available, and
a second transmission window zone where all resources are potentially free, wherein the set of candidate resources includes one or more resources out of the resources of the second transmission window zone.

In embodiments, the first transmission window zone comprises a length that is equal to a length W of the reservation window minus a length G of the gap minus one slot.

In embodiments, a length of the gap window zone is equal to the length G of the gap.

In embodiments, the second transmission window zone comprises a length of one slot.

Embodiments of the present invention, as mentioned above, provide improvements and enhancements of the partial sensing procedure of battery operated UEs, for example, VRU-UEs, such as P-UEs, as it may be employed in NR sidelink communications, like V2X communications (e.g., NR V2X transmission mode 2) or the like. In the following, several aspects of the present invention are described which provide for enhancements with regard to at least one out of power consumption, flexibility, complexity, forward compatibility, overhead, specification impact, latency and robustness. The subsequently described aspects may be used independently from each other or some or all of the aspects may be combined.

In accordance with embodiments, further improvements can be achieved by implementing one or a combination of two or more of the following options:
1. Exploiting fast decoding of 1st stage SCI and possibly 2^{nd} stage SCI such that the time between the end of the sensing window and the resource selection trigger T_{proc,0} is 0 slots, i.e. decoding is completed within the same slot where the SCI arrives over the air.
2. Optionally, moving resource selection algorithms from upper layers to the physical layer avoiding time consuming back and forth signaling and exclude asynchronous processing in higher layers. By that achieving that the maximum time between (re) selection trigger and start of selection window T_{proc,1} is 0 slots such that the resource selection is completed within the same slot where the SCI arrives over the air and the UE is ready to transmit in the next slot. The algorithm could be kept in upper layers if it achieves the requirement for T_{proc,1}=0.
3. Flexible resource shaping in time and frequency domain. That means, one or multiple transport blocks (e.g., minimum resource blocks) can be transmitted within one slot distributed over multiple subchannels or in one subchannel but distributed over multiple slots or any suitable combination of number of slots and subchannels.
4. Reduction of the so called window W, which sets the maximum time span within a resource reservation and all corresponding reserved resources occur.
5. Beside resource reservation, a new type of look-ahead information can be added (more details further below in section 9.4 to support the flexible resource shaping which is advantageously mapped on any stage of SCI. The look-ahead information and reduced window W allows a single shot sensing for resource selection. That means a UE does not need to rely on continuous sensing. In principle, it can wake up any time and a sensing time of a few slots or even only one slot is sufficient to gain the full picture of the resource occupation announced by all other UEs, if the sensing window and the window W within all resource reservations corresponding reserved resources occur are selected as described in section 9.5 below.
6. Support resource selection without resource reservation by adding look-ahead information into SCI that also publishes the intention for resource occupation of a corresponding transmitting UE in another way. In other words, each UE is obliged to set this information in its SCI. In the exemplary embodiment 1 described in section 9.2.1 the resource selection shall be supported without resource reservation, i.e. resource reservation is not allowed at all.

Below, in section 9.1 different options are described that allow for fast decoding and single shot sensing. These different options can be implemented by themselves or at least two of these options can be combined with each other.

Afterwards, in section 9.2, exemplary embodiments are described. Specifically, in section 9.2.1., exemplary embodiment 1 is proposed, which provides fast decoding and single shot sensing and does not allow resource reservation. In section 9.2.2., exemplary embodiment 2 is proposed, where the look-ahead information to support the flexible resource shaping may be combined with state of the art frequency and time assignment of a resource reservation. In section 9.2.3. exemplary embodiment 3 is described that uses only state of the art reservation, however, implementing all options from above to realize single shot sensing.

Note that exemplary embodiment 3 provides fast decoding and single shot sensing. Thereby, in embodiments, direct resource selection without prior reservation is not excluded. However, for perfect prediction of resource availability, in embodiments, resource reservation always can be used by all UEs. Thus, this is the advantageous selection mechanism of exemplary embodiment 3. Resource selections without prior reservation introduce an element of unpredictability that deteriorates the collision probability and thus should be avoided.

Note that in embodiments, “sensing” is essentially defined as the decoding of the control channel SCI and retrieving its information. Thereby, RSSI and RSRP measurements may still be part of sensing as additional metrics for assessment of the sensing result.

### 9.1. Supporting Options

### 9.1.1. Fast SCI Decoding

Today's chip technologies enable extreme fast signal processing which is crucial for NR. The new numerologies with higher sub-carrier spacing have shorter slot lengths. For example, μ=3 with 120 KHz sub-carrier spacing has a slot length of only 125 μs. μ=4 is even more challenging.

Use cases like self-contained slots entail extremely fast processing. NR would not be realistic if modern chip technologies do not conform to that.

In NR R16.0, it was agreed to apply polar channel coding for the control information. A hardware implementation of a polar decoder can be realized such that it needs, for example, <600 cycles.

In accordance with embodiment, clock rates of >1 GHz are possible so that a polar decoding can be processed in about 0.6 μs. Including parsing of the information elements and channel estimation it should be below 1 μs. Assuming a decoding capability of maximum 20 SCIs the information elements of all SCIs can be available within 20 to 30 μs. That means, T_{proc,0}=0 is achievable still leaving margin for T_{proc,1}.

### 9.1.2 Fast Resource Selection

To speed up the procedure, in accordance with embodiments, the resource selection can be moved to the physical layer such that the sensing result needs not be sent to the higher layer. Thus, back and forth signaling is avoided.

In accordance with embodiments, the resource selection process can be as follows:
1. Sensing is triggered by higher layers in conveying.
   1.1. Resource selection parameters for transmission of a transport block (TB) (advantageous solution),
   1.2. and/or information for resources reservation (optional or for backward compatibility).
2. The physical layer may start a single shot sensing, which is explained below.
3. The higher layers possibly provide a TB. Note that in an advantageous solution a TB is always provided, either for initial or re-transmission. In case of a resource reservation the transmission my contain a small TB for initial transmission or an empty PSSCH.
4. In the last slot of the sensing procedure, the physical layer selects a resource as soon as it has decoded the SCIs of the other UEs and prepares the PSCCH for transmission.
5. Transmission of the PSCCH and possibly PSSCH on the selected resource in the slot may be performed directly after the last sensing slot.

This procedure is considerably faster than in conventional technology due to the following methods:
Signaling flows may be in one direction only, i.e. from higher to physical layer without any feedback.
All processing on the physical layer may only be started when the essential information from the higher layer is available, for example as shown in Table 1 below.

In some embodiments, the “resource selection parameters” mentioned in step 1.1. do not mean to include the resource allocation, this is determined in the resource selection step 4. These parameters rather comprise information to determine size and radio parameters, like transport block size, modulation and coding scheme, e.t.c. and information for the resource shaping described in option 3 above. The latter may be based on measurements like PC5 specific measurements of traffic load, density or congestion.

In some embodiments, a pre-requisite may be fast signal processing. Sensing is essentially equivalent to reading SCI. In the slot where sensing ends (in an advantageous solution it may be a single slot) SCI decoding, resource selection and packet formatting is advantageously to be completed such that transmission may be done in the subsequent slot.

In accordance with embodiments, single shot sensing means, that the UE may wake up at an arbitrary time for a single sensing event. Regular and continuous sensing is not needed. Indeed in practice, a UE usually will wake up periodically for other reasons as to listen for messages. However, it can ad hoc initiate a transmission independently. For example, a UE may wake up as per its DRX configuration provided by the higher layers, e.g. the RRC if the DRX is optionally activated for the UE, and does not need any sensing information from previous DRX cycles. Any asynchronous wake-up trigger, e.g. switching on the UE, switching to mode 2 after losing coverage or any other kind of trigger that might be introduced in the future are supported by single shot sensing.

The following Table 1 provides a possible implementation of information elements configuring a sensing of a common transmission resource pool. Thereby, the marked section describes an example of a new information element to support one-shot sensing.

CommTxPoolSensingConfig information element

| | |
|---|---|
| -- ASN1START | |
| SL-CommTxPoolSensingConfig-r14 : := | SEQUENCE { |
| pssch-TxConfigList-r14 | SL-PSSCH-TxConfigList-r14, |
| thresPSSCH-RSRP-List-r14 | SL-ThresPSSCH-RSRP-List-r14, |
| restrictResourceReservationPeriod-r14 | SL-RestrictResourceReservationPeriodList-r14 |
| OPTIONAL, -- Need OR | |
| probResourceKeep-r14 | ENUMERATED {v0, v0dot2, v0dot4, v0dot6, v0dot8, |
| | spare3, spare2, spare1}, |
| oneshot-SensingConfig-r* | SEQUENCE { |
| pssch-TxConfigList-r1* | SL-PSSCH-TxConfigList-r1*, |
| thresPSSCH-RSRP-List-r1* | SL-ThresPSSCH-RSRP-List-r1*, |
| -lookaheadinformationconunter | OPTIONAL, INTEGER (1..8) , |
| p2x-SensingConfig-r14 | SEQUENCE { |
| minNumCandidateSF-r14 | INTEGER (1..13), |
| gapCandidateSensing-r14 | BIT STRING (SIZE (10)) |
| } OPTIONAL, -- Need OR | |
| sl-ReselectAfter-r14 | ENUMERATED {n1, n2, n3, n4, n5, n6, n7, n8, n9, |
| | spare7, spare6, spare5, spare4, spare3, |
| spare2, | |
| | spare1} OPTIONAL -- Need |
| OR | |
| } | |
| } | |

### 9.1.3 Flexible Resource Shaping

The smallest possible, i.e. atomic, resource is defined by one sub-channel and one slot (=minimum resource block). Conventionally, sub-channels in only one slot are aggregated to accommodate transport blocks of bigger size. In other words, atomic resources are only aggregated in the frequency domain.

In accordance with embodiments, flexible resource shaping is supported. Flexible resource shaping means that resource aggregation is possible in time and frequency domain. That means, one or multiple-transport blocks can be transmitted within one slot distributed over multiple subchannels or in one subchannel but distributed over multiple slots or any suitable combination of number of slots and subchannels.

This simplifies the resource selection decision since it provides an additional dimension to adapt to any number of consecutive free subchannels, which is influenced by the density of traffic. For example, it is easier to find free resources the lower the number of sub-channels is thus reducing the probability of collisions. Consequently, resource shaping is an instrument to adapt to the density of traffic. For example, if the resource occupation is sparse aggregation in the frequency domain can be of advantage, if it is crowded aggregation in the time domain is better.

### 9.1.4 Look Ahead Information

In accordance with embodiments, the look-ahead information provides an improved (e.g., accurate as possible) preview of the resource occupation pattern in the near future. To reduce (or even minimize) the collision probability it supports a new (e.g., much faster) procedure for resource selection described in section 9.1.2.

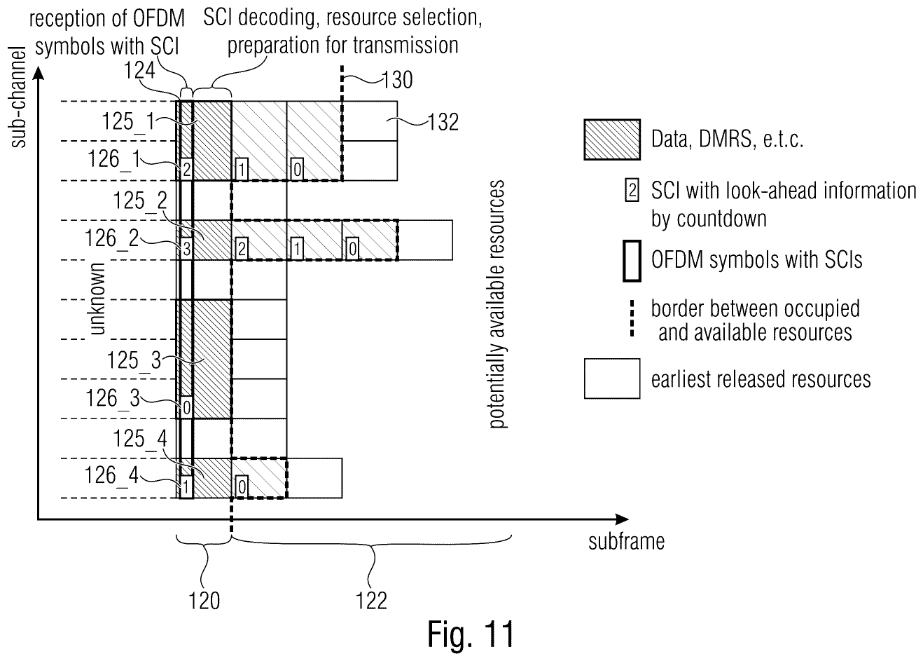

With state of the art resource reservation one type of look ahead information already exists. To support flexible resource shaping, in accordance with embodiments, a new type of look ahead information is proposed. This can be very compact using a few bits in SCI stage 1 or stage 2 for, e.g., a countdown that indicates how long in the near future the resource will be kept by the corresponding UE, wherein the number of bits can be (pre-) configured by the higher layer signaling, e.g., RRC signaling. FIG. 11 below illustrates the example of a countdown value. In this example, the number of bits sets the planning horizon. If, for example, 3 bits are used and the resource will be kept for longer than 8 slots, the counter stays constant at its maximum value 7 and counts-down if the occupation is <8 slots, accordingly. The value 0 indicates that the resource will be free at the next slot and can be selected by another UE.

For other applications, the counter can be extended by additional bits or a dedicated counter to indicate when the corresponding UE plans to resume the resource.

Naturally, in embodiments, also other kinds of look-ahead information might be defined.

### 9.1.5 Window W Reduction

In accordance with embodiments, the maximum time span within a resource reservation and all corresponding reserved resources, known as window W, is reduced, thereby reducing the sensing time and thus saving power. In some embodiments, the window W should be as short as possible but may depend on factors like QoS, i.e. priority of transmission, as well as on the traffic type. Therefore, in some embodiments, a configuration by higher layer signaling might be entailed, e.g., by RRC through IE SL-ResourcePool with a new information element:

sl-SensingWindow-r16 ENUMERATED {ms1, ms2, . . . ms100, ms1100} OPTIONAL, . . . Need M

If selecting the smallest possible window size W=1, i.e. only one slot, transmission is done in the next slot after sensing. When reading the SCIs in this slot all information about resource occupation are present for resource selection by the look-ahead information. This is a true single shot sensing in a single slot. As consequence, this use case excludes resource reservation.

In context of exemplary embodiment 3 (see section 9-2.3) a shortened sensing of a duration equal to the window size W>1 would likewise yield the complete information about resource occupation by resource reservation and look-ahead information. This use case combines the look-ahead information with and includes resource reservation.

### 9.2. Resource Selection Procedures

In accordance with embodiments, at least two of the options described in section 9.1 can be combined (e.g., in different ways) to specify solutions for different resource selection procedures, as will become clear from the subsequently described exemplary embodiments.

### 9.2.1 Exemplary Embodiment 1

In accordance with this embodiment, resource reservation is not allowed. That means any time a UE needs to select a resource for transmission it has to compete for a new one and selects it at the earliest possible opportunity (can be the very next slot) without further delay by an intermediate reservation. This ensures lowest latencies, reduces the collision probability and optimizes resource utilization. With the steadily new selected resources, an inherent frequency hopping effect is achieved. As additional advantage, procedures like preemption become obsolete.

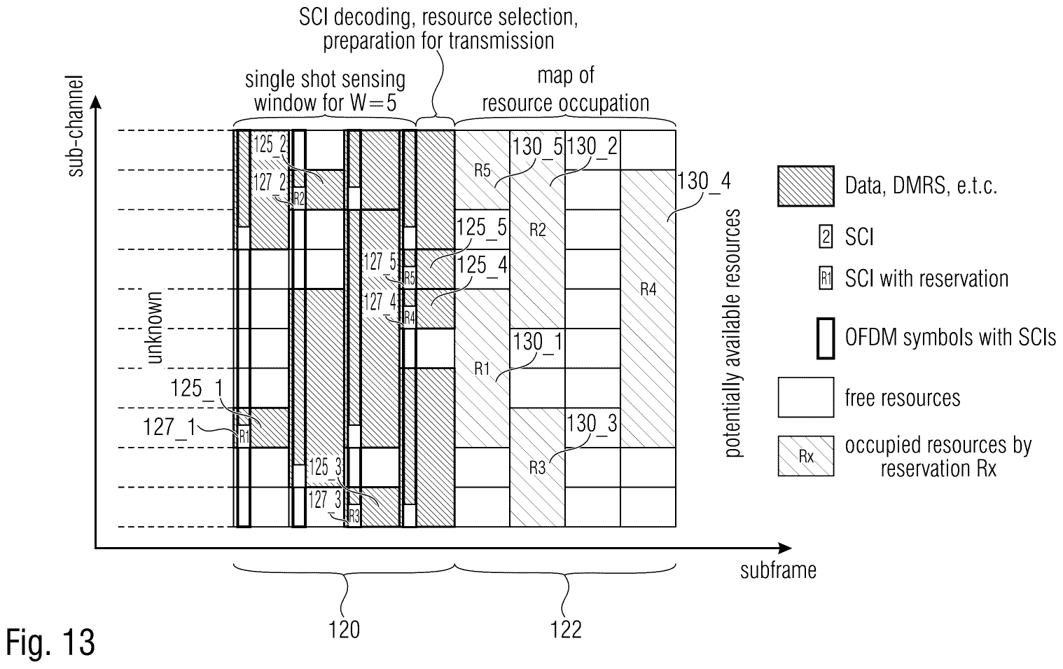

FIG. 11 shows in a diagram an occupation of resources of the wireless communication network during a sensing window 120 of the single shot sensing based on which the transceiver determines a sensing information describing free resources and/or occupied resources in a following transmission window 122 (single shot sensing supported by look-ahead information). Thereby, the ordinate denotes the sub-channels and the abscissa the slots. As indicated in FIG. 13, the sidelink control information 126_1-126_4 transmitted, e.g., at a beginning of a respective slot 125_1-125_4, signals a number of slots immediately following the respective slot that are occupied by a transceiver of the wireless communication system. For example, the sidelink control information 126_1 transmitted in slot 125_1 signals that the immediately following 2 slots are occupied, wherein the sidelink control information 126_2 transmitted in slot 125_2 signals that the immediately following 3 slots are occupied, wherein the sidelink control information 126_3 transmitted in slot 125_3 signals that the immediately following 0 slots are occupied, and wherein the sidelink control information 126_4 transmitted in slot 125_4 signals that the immediately following 1 slots are occupied.

In other words, FIG. 11 illustrates an embodiment without resource reservation. The box 124 represents the OFDM symbols within a single slot with the SCIs of all transmitting UEs. That means, W=1, i.e. only one slot. As a consequence, this use case excludes resource reservation.

In other words, a regular sensing like in partial sensing is not needed. In an extreme example, a UE may be inactive for an arbitrary time and only one period of, i.e. single shot, sensing in one slot is sufficient to obtain all information for a resource selection decision. In reality, a UE repeatedly or periodically will scan for messages, like CAM for discovery. The sensing and resource selection procedure, however, can in principle be done independently of other procedures. On the other hand for power saving any wake-up opportunity should be used to execute as many as possible procedures at the same time. As example, if the UE wakes up to scan for messages it is beneficial to execute sensing, selection and transmission as much as possible in parallel.

Decoding the SCIs in this slot to obtain the look-ahead information, represented by a countdown value, publishes the complete pattern of occupied sub-channels in the near future. The green line 130 marks the border between occupied and free resources 132.

Collisions can be classified by two categories, collisions with an ongoing transmission and on free resources. Ongoing transmission occurs if it is started in slots that are covered by sensing, for example in the gap between sensing and resource selection. With the look-ahead information a collision with ongoing transmission is eliminated if a UE selects free resources from the first slot after the green border (W=1). This entails fast SCI decoding and resource selection (see sections 9.1.1 and 9.1.2) such that W=1 can be configured.

In the ideal case, all UEs have the same information. However, since the UEs have no chance to know the decision on the resource selection of the other UEs collisions on free resources may occur. This cannot be avoided with any kind of method. Note that state of the art resource selection suffers from collision with ongoing transmission due to the longer time between sensing and resource selection.

Since no reservation is allowed no pre-emption is possible and a UE always tries to select resources that are available the question arises if the priority field in SCI is needed. A possible use case is, if under high load on the resource pool a high priority transmission is forced to select an occupied resource it could interfere with high power and let the interfered lower priority signal retransmit. On the other hand resource shaping helps to avoid the need for occupied resources.

9.2.2 Exemplary Embodiment 2: Combination of Exemplary Embodiment 1 with Conventional Resource Reservation

In accordance with embodiments, the look-ahead information, e.g. represented by a countdown, can be combined with the resource reservation mechanism of rel. 16 NR V2X. This may be entailed for backward compatibility. Resource reservation and the look-ahead information can both be regarded as look-ahead, since both inform about the intention of a UE regarding resource occupation in the subsequent slots.

Resource reservation cannot be done with W=1 since the resource reservation is transmitted before the reserved resource is used for data transmission. So, at least two slots are needed. A shortened sensing of a duration equal to a window size W>1 would likewise yield the complete information about resource occupation by resource reservation and look-ahead information.

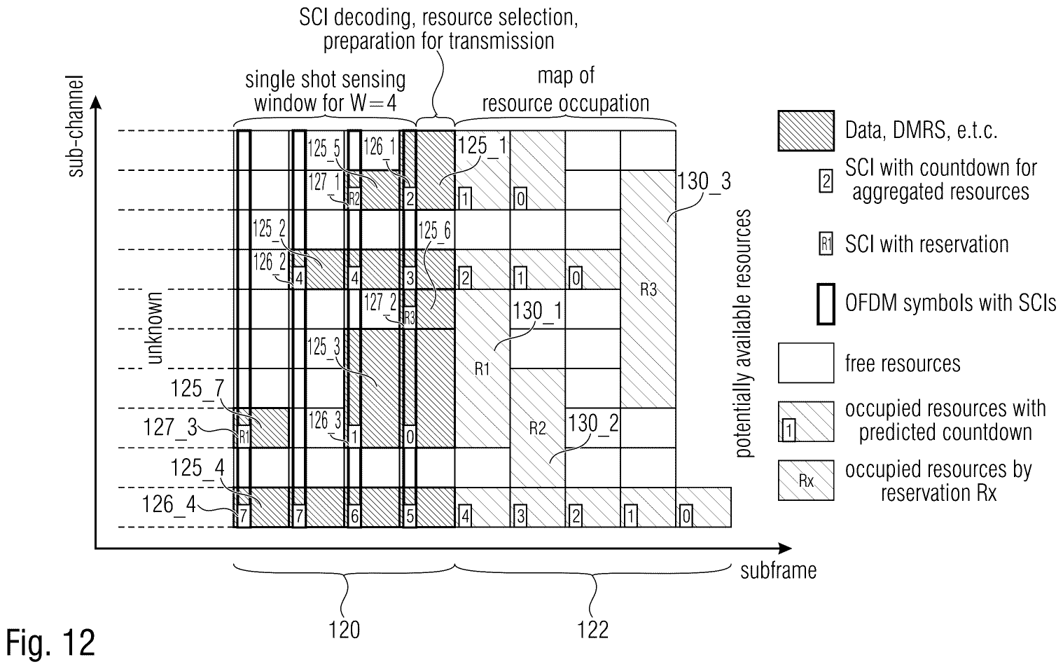

This use case which combines the look-ahead information with and includes resource reservation is illustrated in FIG. 12 assuming W-5. Note that the slot with the reservation information is included in W, so that sensing spans over W-1. Since all resource selections are fulfilled latest W-1 slots after the slot with the reservation information, a single shot sensing with window size of W-1 is sufficient to obtain the complete occupation pattern over the next slots.

In detail, FIG. 12 shows in a diagram an occupation of resources of the wireless communication network during a sensing window 120 of the single shot sensing based on which the transceiver determines a sensing information describing free resources and/or occupied resources in a following transmission window 122 (single shot sensing supported by look-ahead information with resource reservation). Thereby, the ordinate denotes the sub-channels and the abscissa the slots.

As indicated in FIG. 12, the sidelink control information 126_1-126_4 transmitted, e.g., at a beginning of a respective slot 125_1-125_4 signals a number of slots immediately following the respective slot that are occupied a transceiver of the wireless communication system. For example, the sidelink control information 126_1 transmitted in slot 125_1 signals that the immediately following 2 slots are occupied, wherein the sidelink control information 126_2 transmitted in slot 125_2 signals that the immediately following at least 4 (in total 5) slots are occupied, wherein the sidelink control information 126_3 transmitted in slot 125_3 signals that the immediately following 1 slot is occupied, and wherein the sidelink control information 126_4 transmitted in slot 125_4 signals that the immediately following at least 7 (in total 8) slots are occupied.

Additionally, the sidelink control information 127_1-127_3 transmitted, e.g., at a beginning of a respective slot 125_5-125_7 signals resources that are reserved by a transceiver of the wireless communication system. For example, the sidelink control information 127_1 transmitted in slot 125_5 signals that resources 130_1 (R1) are reserved, wherein the sidelink control information 127_2 transmitted in slot 125_6 signals that resources 130_2 (R2) are reserved, and wherein the sidelink control information 127_3 transmitted in slot 125_7 signals that resources 130_3 (R3) are reserved.

As for the exemplary embodiment 1 (see section 9.2.1) fast SCI decoding and resource selection (see sections 9.1.2 and 9.1.2) is mandated, i.e. the ability to send a resource reservation in the next slot after sensing. Otherwise, collisions with ongoing transmission may occur.

Note that it is possible that a resource selection aggregated over time persists after the map of occupation. This is not a problem since the look-ahead information gives a precise information how far the occupation is prolonged beyond W-1. This situation is illustrated in the bottom subchannel in FIG. 12, assuming 3 bits for the look-ahead countdown.

9.2.3 Exemplary Embodiment 3: Single Shot Sensing with Conventional Resource Reservation

In accordance with embodiments, single shot sensing can be introduced with conventional resource reservation as illustrated in FIG. 13. Again, fast SCI decoding and resource selection (see sections 9.1.1 and 9.1.2) can be implemented to avoid collisions with ongoing transmission.

In detail, FIG. 13 shows in a diagram an occupation of resources of the wireless communication network during a sensing window 120 of the single shot sensing based on which the transceiver determines a sensing information describing free resources and/or occupied resources in a following transmission window 122 (single shot sensing supported by resource reservation). Thereby, the ordinate denotes the sub-channels and the abscissa the slots.

As indicated in FIG. 13, the sidelink control information 127_1-127_5 transmitted, e.g., at a beginning of a respective slot 125_1-125_1 signals resources that are reserved by a transceiver of the wireless communication system. For example, the sidelink control information 127_1 transmitted in slot 125_1 signals that resources 130_1 (R1) are reserved, wherein the sidelink control information 127_2 transmitted in slot 125_2 signals that resources 130_2 (R2) are reserved, wherein the sidelink control information 127_3 transmitted in slot 125_3 signals that resources 130_3 (R3) are reserved, wherein the sidelink control information 127_4 transmitted in slot 125_4 signals that resources 130_4 (R4) are reserved, and wherein the sidelink control information 127_5 transmitted in slot 125_5 signals that resources 130_5 (R5) are reserved.

The reservations 130_1 (R1), 120_4 (R4) and 130_5 (R5) demonstrate certain corner cases. The reserved resources of 130_1 (R1) are located in the first slot after sensing. Since 130_1 (R1) fully utilizes the window size W and the slots with the transmission of the reservation data and the resource occupation is within W=5, sensing starts W-1 slots in advance. The size of W can take any value, e.g., W=32, which can be (pre-) configured, for example, by RRC signaling.

The reservation 130_4 (R4) is sent in the last slot of the sensing window. Thus, the latest resource occupation is W-1 slots later. After this point all resources are potentially free since no reservation can exist. However, if the UE intends to transmit there sensing should be prolonged up to this point. Otherwise, ongoing transmission can start in between causing collisions.

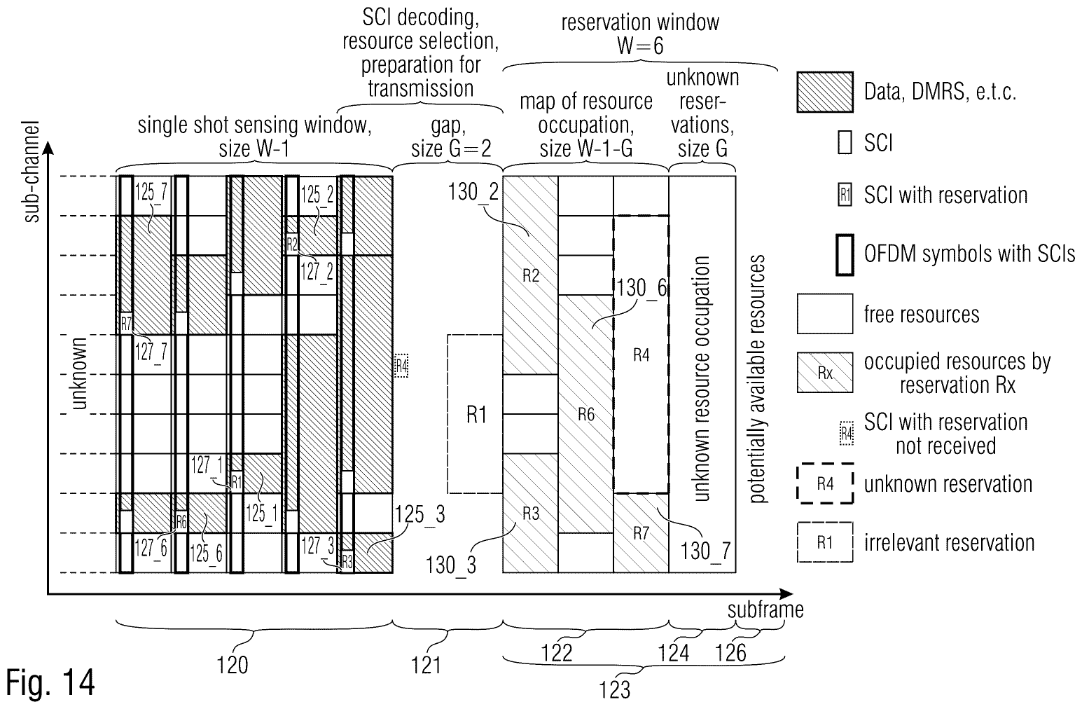

In other words, FIG. 13 represents an ideal example of the principle. The collision probability is lowest if the number of slots, i.e., the gap between the last slot with sensing and the first slot with transmission is zero as shown in FIG. 13. However, a UE may use some time for the processing after resource selection triggering time and before selecting radio resources. Note that the processing time could take any value, including zero-processing time, depending on the UE capability. For processing reasons a gap of one or more slots may be inserted as shown in FIG. 14.

In detail, FIG. 14 shows in a diagram an occupation of resources of the wireless communication network during a sensing window 120 of the single shot sensing based on which the transceiver determines a sensing information describing free resources and/or occupied resources in a following reservation window 123, wherein there is a gap 121 between the sensing window 120 and the reservation window 123 (single shot sensing supported by resource reservation with gap between end of sensing and transmission). Thereby, the ordinate denotes the sub-channels and the abscissa the slots.

As indicated in FIG. 14, the sidelink control information 127_1-127_7 transmitted, e.g., at a beginning of a respective slot 125_1-125_7 signals resources that are reserved by a transceiver of the wireless communication system. For example, the sidelink control information 127_1 transmitted in slot 125_1 signals that resources 130_1 (R1) are reserved, wherein the sidelink control information 127_2 transmitted in slot 125_2 signals that resources 130_2 (R2) are reserved, wherein the sidelink control information 127_3 transmitted in slot 125_3 signals that resources 130_3 (R3) are reserved, wherein the sidelink control information 127_6 transmitted in slot 125_6 signals that resources 130_6 (R6) are reserved, and wherein the sidelink control information 127_7 transmitted in slot 125_7 signals that resources 130_7 (R7) are reserved.

In embodiments, this gap 121 may be subdivided into and shared by several processing tasks, for example, analysis of the sensing results, decision making for resource selection and preparation for transmission. As can be seen in FIG. 14, such a gap 121 has some implications that may increase collision probability,
Since sensing may not be done in the gap or cannot be processed in time, reservations are missed (see SCI with reservation R4 in FIG. 14) and the corresponding resources seem to be available (see red box enclosing the reserved resources of R4). The UE might select resources overlapping with such unknown resource causing a collision.
Resource reservations received by sensing may be located in the gap and thus are irrelevant.
The map of resource occupation derived from sensing is reduced. The size of the gap 212 is considered by the resource selection.

Indeed, for lowest collision probability, in embodiments, the gap 121 length and the reservation window 123 size W is taken into account for the sensing window 120.

FIG. 8 illustrates how sensing and resource selection depends on the reservation window size W and the gap length G. For explanatory reasons, W=6 and G=2 is used as example. Note, that 3GPP has agreed on W=32, but the principle is the same for any other value.

As explained above for G=0 (see FIG. 13) it follows from the rule that all selected resources, i.e. initial allocation and reservations, occur in a window 123 of size W, that the minimum sensing window size to obtain the maximum information about future resource occupation is W-1. This is provides the best power saving at lowest collision probability. Due to the gap the reservation window W (123) can be subdivided into three zones (or window zones 122, 124, 126) with different information quality,
1. The map of future resource occupation (e.g., first transmission window zone 122) that can be derived from the sensing information beginning after the gap. Compared to the case without gap in FIG. 3 it is reduced by the gap length to size W-1-G. The information quality is good but not perfect, since the sensing and transmitting UE may miss sensing information if other UEs transmit in the same slot or in the gap.
2. The Zone (e.g., unknown window zone 124) of size G where no sensing information is available but resource selections by other UEs may exist. Thus only random selection is applicable in zone 2.
3. W-1+G slots after the end of the sensing window (i.e., in a second transmission window zone 126) all resources are potentially free. Resource selections from other UEs may exist only if they transmit reservations in the same slot.

From that follows that zone 2 provides the lowest, zone 1 a better and zone 3 the best information quality on resource occupation. Consequently, resource selections in zone 2 have the highest, in zone 1 a lower and in zone 3 the lowest collision probability. It is noted here that due to the limitation by the reservation window only one slot is available for resource selection or reservation in zone 3.

That means, for lowest collision probability, resource selections in zone 2 should be avoided and zone 3 should be advantageous for the last resource reservation.

A shorter sensing window 120 size is possible but would increase the collision probability. If the sensing window 120 is reduced to zero the resource selection gradually approaches the behavior of and turns into a random selection.

In embodiments, a resource selection is triggered at the physical layer when packet arrival from higher layers. In the case of an aperiodic traffic, it is not possible to foresee triggering resource selection time. Thus, best power saving at lowest collision probability can be achieved if the UE starts sensing immediate after traffic arrival is triggered and continuous for W-1 slots, as described above.

In the case of periodic traffic, the resource selection triggering time is known, and thus the sensing can be initiated before the resource selection triggering time which results in latency improvements.

Though not optimal for power saving in case of aperiodic traffic it is possible in principle to start sensing blindly without that a traffic arrival trigger has occurred. This may be needed if, for example, QoS entails low-latency. Assume, that the UE is able to make a prediction with more or less accuracy that a traffic arrival will occur with a certain probability soon. If the prediction is accurate enough the traffic arrival trigger might occur already within the sensing window 120, i.e. after the blind start of the sensing but before the sensing window 120 size of W-1 slots has been reached. In this case sensing is advantageously continued until the end of the window. However, for least latency it can also be stopped at the traffic arrival trigger, accepting incomplete sensing information and thus transmission with higher collision probability.

If the prediction is not accurate enough the traffic arrival may take longer than the sensing window 120 size of W-1 slots. Sensing may then be continued until a traffic arrival trigger occurs. In this case, only the sensing information from the latest W-1 slots before the trigger is useful for the decision making for resource selection.

### 9.3. Further Embodiments

V2X mode 2 sidelink resource selection is based on sensing. Conventionally, it is done by RSSI and/or RSRP measurements. This is not sufficient for NR and thus is based on decoding of the control channel SCI and retrieving its information. Embodiments are based on one or a combination of at least two out of the following options:
Fast SCI decoding and resource selection such that resources can be occupied in the next slot after sensing.
Flexible resource shaping in time and frequency domain.
Look-ahead information about the resource occupation in the future.
Short time span W where a resource reservation and corresponding reserved resources occur.
Support resource selection without resource reservation.

This enables a very dynamic resource selection that does not need continuous sensing. Rather a power saving single shot sensing is sufficient to obtain accurate information about the resource occupation in the near future. According to above described exemplary embodiment 1, i.e. without reservation, each UE has to compete for a new resource if it wants to transmit. This ensures most efficient resources utilization.

Embodiments described herein provide one or more of the following benefits:
low latency,
power saving,
inherent frequency hopping,
improved (e.g., best) resource utilization (e.g., no un-used reservations, no
bandwidth fragmentation due to mismatching periodicity), and
reduced (e.g., lowest possible) collision probability.

### 10. Further Embodiments

Embodiments described herein provide ways that sidelink can access the unlicensed band. The main benefit is access to large portions of bandwidth, enabling new use cases, improved performance, traffic off-loading.

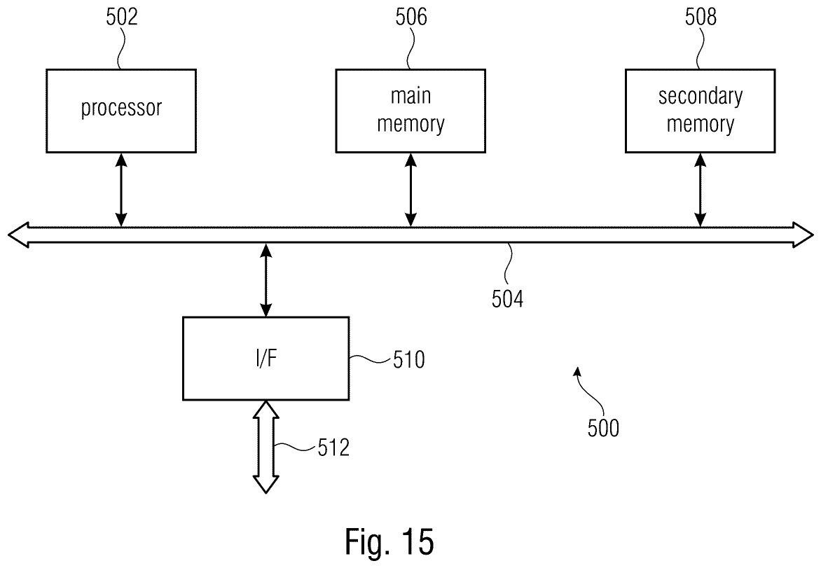

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 15 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### LIST OF REFERENCES

[1] EN 301 893 v 2.1.1 (2017-05)-5 GHz RLAN; Harmonised Standard covering the essential requirements of article 3.2 of Directive 2014/53/EU
[2] TS 37.213 v 16.8.0 Physical layer procedures for shared spectrum channel access

### List of Abbreviations

3GPP third generation partnership project
AIM assistance information message
AGC automatic gain control
AL alert limit
AMF access and mobility management function
ARAIM advanced receiver autonomous integrity monitoring
BS base station
BWP bandwidth part
CA carrier aggregation
CC component carrier
CCA clear channel assessment
CBG code block group
CBR channel busy ratio
COT channel occupancy time
CP cyclic prefix
CPE cyclic prefix extension
D2D device-to-device
DAI downlink assignment index
DCI downlink control information
DL downlink
FBE frame based equipment
FFT fast Fourier transform
FR1 frequency range one
FR2 frequency range two
GMLC gateway mobile location center
gNB evolved node B (NR base station)/next generation node B base station
GNSS global navigation satellite system
HAL horizontal alert limit
HARQ hybrid automatic repeat request
IoT internet of things
ITS intelligent transport system
LBE load based equipment
LBT listen before talk
LCS location services
LMF location management function
LPP LTE positioning protocol
LTE long-term evolution
MAC medium access control
MCR minimum communication range
MCS modulation and coding scheme
MIB master information block
MO-LR mobile originated location request
MT-LR mobile terminated location request
NB node B
NI-LR network induced location request
NR new radio
NRPPa NR positioning protocol-annex
NTN non-terrestrial network
NW network
OCB occupied channel bandwidth
OFDM orthogonal frequency-division multiplexing
OFDMA orthogonal frequency-division multiple access
PBCH physical broadcast channel
PC5 interface using the sidelink channel for D2D communication
PDCCH physical downlink control channel
PDSCH physical downlink shared channel
PL protection level
PLMN public land mobile network
PPP point-to-point protocol
PPP precise point positioning
PRACH physical random access channel
PRB physical resource block
PRS public regulated services (Galileo)
PSCCH physical sidelink control channel
PSSCH physical sidelink shared channel
PUCCH physical uplink control channel
PUSCH physical uplink shared channel
PVT position and/or velocity and/or time
PVT position, velocity and time
RAIM receiver autonomous integrity monitoring
RAN radio access networks
RAT radio access technology
RB resource block
RNTI radio network temporary identifier
RP resource pool
RRC radio resource control
RS reference symbols/signal
RTK real time kinematics
RTT round trip time
SBAS space-based augmentation systems
SBI service based interface
SCI sidelink control information
SI system information
SIB sidelink information block
SL sidelink
SSR state space representations
TTI short transmission time interval
TDD time division duplex
TDOA time difference of arrival
TIR target integrity risk
TRP transmission reception point
TTA time-to-alert
TTI transmission time interval
UAV unmanned aerial vehicle
UCI uplink control information
UE user equipment
UL uplink
UMTS universal mobile telecommunication system
V2x vehicle-to-everything
V2V vehicle-to-vehicle
V21 vehicle-to-infrastructure
V2P vehicle-to-pedestrian
V2N vehicle-to-network
P-UE pedestrian UE
V-UE vulnerable UE

1. A transceiver of a 4th or 5th generation mobile communication system,
wherein the transceiver is configured to operate in a sidelink mode,
wherein the transceiver is configured, in the sidelink mode, to transmit or receive signals using radio resources in an unlicensed band,
wherein the unlicensed band is one out of the following unlicensed bands:
the 2.4 GHz band,
the 5 GHz band with the exception of the intelligent transport system, ITS, band,
the 6 GHz band,
the 60 GHz band,
the 57 GHz to 71 GHz band,
unlicensed bands in FR2 range,
wherein the transceiver is configured, when using the radio resources for transmitting a signal, to transmit a fifth control signal, the fifth control signal indicating when the radio resources will be free and/or a remaining time of the channel occupancy time, COT,
wherein the transceiver is configured to transmit the fifth control signal only to those transceivers of the wireless communication system that are located within a predefined distance to the transceiver or that comprise a reference signal received power, RSRP, above a predefined threshold.

2. The transceiver according to claim 1,
wherein the transceiver is configured to use the radio resources for transmitting or receiving signals over the Uu interface and/or the PC5 interface.

3. The transceiver according to claim 1,
wherein the radio resources are defined by a resource pool.

4. The transceiver according to claim 1,
wherein the transceiver is configured to receive a first control signal, the first control signal indicating a start and/or an end of a period during which the radio resources can be used by the transceiver for transmitting and/or receiving signals,
wherein the transceiver is configured to use the radio resources for transmitting and/or receiving signals during the period indicated by the first control signal.

5. The transceiver according to claim 1,
wherein the radio resources are available/active during one or more preconfigured periods,
wherein the transceiver is configured to perform at a start of a respective period a clear channel assessment, CCA, procedure in order to determine whether the radio resources is free,
wherein the transceiver is configured to use the radio resources for transmitting and/or receiving signals only when the radio resources are free.

6. The transceiver according to claim 5,
wherein the transceiver is configured to transmit, when the radio resources are free, a second control signal to one or more other transceivers of the wireless communication system, the second control signal indicating that the resource pool is used by the wireless communication system during the respective period.

7. The transceiver according to claim 1,
wherein the radio resources are available/active during one or more preconfigured periods,
wherein the transceiver is configured to receive a third control signal from another transceiver of the wireless communication system, the third control signal indicating whether the radio resources are used by the wireless communication system during a respective period,
wherein the transceiver is configured to use the radio resources for transmitting and/or receiving signals only when the third control signals indicates that the radio resources is used by the wireless communication system during a respective period.

8. The transceiver according to claim 1,
wherein the transceiver is configured to perform a single-shot-sensing on or more resources of the radio resources prior to transmitting a signal to another transceiver of the wireless communication system, in order to obtain a sensing information,
wherein the transceiver is configured to determine, for transmitting the signal, a set of candidate resources out of the radio resources based on the sensing information,
wherein the transceiver is configured to select, for transmitting the signal, resources out of the set of candidate resources and to transmit the signal using the selected resources.

9. The transceiver according to claim 8,
wherein the radio resources are accessed in the time domain on a slot basis,
wherein the transceiver is configured to select the resources out of the set of candidate resources for transmitting the signal and to be ready to transmit the signal until an end of a last occurring slot of a sensing window used for said single-shot-sensing.

10. The transceiver according to claim 1,
wherein the transceiver is configured to receive a fourth control signal from another transceiver of the wireless communication system that is currently using the radio resources, the fourth control signal indicating when the radio resources are free and/or a remaining time of the channel occupancy time, COT.

11. The transceiver according to claim 1,
wherein the remaining channel occupancy time is signaled by means of an entry to a list or a number of slots or symbols,
or wherein the remaining channel occupancy time, COT, is signaled by means of a 2^{nd} stage sidelink control information.

12. The transceiver according to claim 11,
wherein the 2^{nd} stage sidelink control information comprises one or more out of the following information:
a priority,
a time resource,
a periodicity of transmission,
a frequency,
a communication range,
a zone or geographical area,
a countdown value.

13. The transceiver according to claim 1,
wherein the radio resources are first radio resources, wherein the transceiver is configured to transmit transport block using the first radio resources in case that a size of the transport block is higher than a threshold, and to transmit the transport block using second radio resources in case that the size of the transport block is equal to or smaller than the threshold,
or wherein the transceiver is configured to perform blind retransmissions on different frequencies on the radio resources in order to fulfill a minimum occupied channel bandwidth, OCB, of the unlicensed band,
or wherein the transceiver is configured to transmit a signal using a sub-channel of the radio resources,
or wherein the transceiver is configured to select resources out of the radio resources for transmitting a signal such that a time gap between a last occupied resource of the radio resources and a first resource used for transmission is smaller than a predefined value,
or wherein the transceiver is configured to perform a clear channel assessment, CCA, procedure in order to determine whether the radio resources are free in case that a time gap between a last occupied resource of the radio resources and a first resource scheduled to be used by the transceiver for transmitting a signal is greater than a predefined value, wherein the transceiver is configured to use the radio resources for transmitting and/or receiving signals only when the resource pool is free.

14. The transceiver according to claim 1,
wherein resources for transmitting a signal are allocated to the transceiver autonomously or by a base station of the wireless communication system on a sub-slot or mini slot basis.

15. The transceiver according to claim 14,
wherein the transceiver is configured to use, for transmitting a signal, a cyclic prefix extension in order to start transmission of a signal before OFDM symbol boundaries.

16. The transceiver according to claim 1,
wherein the transceiver is configured to start a transmission of a signal as soon as a clear channel assessment, CCA, procedure indicates that a channel is free, wherein the transceiver is configured to start the transmission of the signal applying a cyclic prefix extended by a time between the time the channel became free and a slot boundary,
or wherein the transceiver is configured to receive a sixth control signal from a base station of the wireless communication system, the sixth control signal comprising a semi static channel access information indicating that a channel of the radio resources is to be accessed based on a semi static period basis, wherein the transceiver is configured to transmit a signal on the radio resources in dependence on the semi static channel access information.

17. A method for operating a transceiver of a 4th or 5th generation mobile communication system, the method comprising:
operating the transceiver in a sidelink mode,
transmitting or receiving signals using radio resources in an unlicensed band,
wherein the unlicensed band is one out of the following unlicensed bands:
the 2.4 GHz band,
the 5 GHz band with the exception of the intelligent transport system, ITS, band,
the 6 GHz band,
the 60 GHz band,
the 57 GHz to 71 GHz band,
unlicensed bands in FR2 range,
transmitting a fifth control signal when using the radio resources for transmitting a signal, the fifth control signal indicating when the radio resources will be free and/or a remaining time of the channel occupancy time, COT,
wherein the fifth control signal is transmitted only to those transceivers of the wireless communication system that are located within a predefined distance to the transceiver or that comprise a reference signal received power, RSRP, above a predefined threshold.

18. A transceiver of a 4th or 5th generation mobile communication system,
wherein the transceiver is configured to operate in a sidelink mode,
wherein the transceiver is configured, in the sidelink mode, to transmit or receive signals using radio resources in an unlicensed band,
wherein the unlicensed band is one out of the following unlicensed bands:
the 2.4 GHz band,
the 5 GHz band with the exception of the intelligent transport system, ITS, band,
the 6 GHz band,
the 60 GHz band,
the 57 GHz to 71 GHz band,
unlicensed bands in FR2 range,
wherein the transceiver is configured, when transmitting a signal on the radio resources that extends over two or more slots, to transmit a dummy symbol on a guard symbol of a respective slot in order to block the radio resources.

19. A method for operating a transceiver of a 4th or 5th generation mobile communication system, the method comprising:
operating the transceiver in a sidelink mode,
transmitting or receiving signals using radio resources in an unlicensed band,
wherein the unlicensed band is one out of the following unlicensed bands:
the 2.4 GHz band,
the 5 GHz band with the exception of the intelligent transport system, ITS, band,
the 6 GHz band,
the 60 GHz band,
the 57 GHz to 71 GHz band,
unlicensed bands in FR2 range,
transmitting a dummy symbol when transmitting a signal on the radio resources that extends over two or more slots, wherein the dummy symbol is transmitted on a guard symbol of a respective slot in order to block the radio resources.

20. A non-transitory digital storage medium having stored thereon a computer program for performing a method for operating a transceiver of a 4th or 5th generation mobile communication system, the method comprising:
operating the transceiver in a sidelink mode,
transmitting or receiving signals using radio resources in an unlicensed band,
wherein the unlicensed band is one out of the following unlicensed bands:
the 2.4 GHz band,
the 5 GHz band with the exception of the intelligent transport system, ITS, band,
the 6 GHz band,
the 60 GHz band,
the 57 GHz to 71 GHz band,
unlicensed bands in FR2 range,
transmitting a fifth control signal when using the radio resources for transmitting a signal, the fifth control signal indicating when the radio resources will be free and/or a remaining time of the channel occupancy time, COT,
wherein the fifth control signal is transmitted only to those transceivers of the wireless communication system that are located within a predefined distance to the transceiver or that comprise a reference signal received power, RSRP, above a predefined threshold,
when the computer program is run by a computer.

21. A non-transitory digital storage medium having stored thereon a computer program for performing a method for operating a transceiver of a 4th or 5th generation mobile communication system, the method comprising:
operating the transceiver in a sidelink mode,
transmitting or receiving signals using radio resources in an unlicensed band,
wherein the unlicensed band is one out of the following unlicensed bands:
the 2.4 GHz band,
the 5 GHz band with the exception of the intelligent transport system, ITS, band,
the 6 GHz band,
the 60 GHz band,
the 57 GHz to 71 GHz band,
unlicensed bands in FR2 range,
transmitting a dummy symbol when transmitting a signal on the radio resources that extends over two or more slots, wherein the dummy symbol is transmitted on a guard symbol of a respective slot in order to block the radio resources,
when the computer program is run by a computer.
